(19) United States
(12) Patent Application Publication
(10) Pub. No.: US 2026/0004220 A1
(43) Pub. Date: Jan. 1, 2026

(54) SYSTEM AND METHOD FOR COMPUTERIZED FACILITATION OF MERGERS AND ACQUISITIONS

(71) Applicant: Miramar Capital, LP, Frisco, TX (US)

(72) Inventor: James T. Jeffries, Plano, TX (US)

(21) Appl. No.: 19/247,561

(22) Filed: Jun. 24, 2025

Related U.S. Application Data
(60) Provisional application No. 63/665,145, filed on Jun. 27, 2024.

(51) Int. Cl. G06Q 10/0637

(52) U.S. Cl. CPC G06Q 10/0637

(57) ABSTRACT

A computerized M&A facilitation system is provided. The system includes a server including merger and acquisition software, the M&A software including: an M&A strategy and governance module

### CROSS-REFERENCE TO RELATED APPLICATIONS

This non-provisional application claims the benefit of, and priority to, U.S. Provisional Application No. 63/665,145, entitled System and Method for Computerized Facilitation of Mergers and Acquisitions, filed on Jun. 27, 2024, which is incorporated by reference in its entirety.

### FIELD OF THE DISCLOSURE

The present disclosure generally relates to software that employs a framework which creates value from mergers and acquisitions, and more particularly to software that employs a framework which creates value from mergers, acquisitions and divestitures employing artificial intelligence.

### BACKGROUND

Mergers and acquisitions (“M&A”) are a critical component of modern business practices.

However, as understood by the inventors, there can be problems with modern M&A practices and frameworks. This can include widely varying scopes of M&A needed which can lead to issues with both flexibility of approach and capturing necessary steps of the M&A practice.

Therefore, as understood by the inventors, there is a need for an adaptable, flexible and detail-oriented approach to M&A that addresses at least some of the drawbacks listed above.

### SUMMARY

In a first aspect, the invention provides a system comprising: a server including merger and acquisition software, the M&A software including: an M&A strategy and governance module.

In a second aspect, the invention provides a method comprising: devising a merger and/or acquisition strategy according to an M&A software; targeting a business for merger and/or acquisition according to the M&A software; conducting preliminary due diligence according to the M&A software; and conducting confirmatory due diligence according to the M&A software.

In a third aspect, the invention provides a method comprising: selecting a question within an M&A software; and analyzing the question/status by both paragraph structure and sentence structure by AI associated with the M&A software.

Other technical features may be readily apparent to one skilled in the art from the following figures, descriptions and claims.

### BRIEF DESCRIPTION OF THE DRAWINGS

For a more complete understanding of this disclosure, reference is now made to the following description, taken in conjunction with the accompanying drawings, in which:

FIG. 1 illustrates an exemplary system that employs M&A software constructed according to the principles of the present application, the M&A software including a plurality of M&A software modules which can further employ an artificial intelligence module and sub-modules.

FIG. 2 illustrates an exemplary flow of an M&A framework performed in the various M&A software modules of FIG. 1.

FIG. 3 illustrates an exemplary method of a M&A framework employed within M&A software performed in the various modules 121-128 of FIG. 1.

FIGS. 4A-D, which are separate portions of a single page, illustrate a plurality of exemplary constituent processes of each of the M&A modules of the M&A software of FIG. 1, wherein each module corresponds to an element of the M&A framework of FIG. 2.

FIGS. 5A-D, which are separate portions of a single page, illustrate exemplary milestones and task level details of Phase 1: “M&A Governance” employed by step 310 of the method of FIG. 3.

FIGS. 6A-F, which are separate portions of a single page, illustrates a first page of exemplary checklist items employed by step 310 of the method of FIG. 3.

FIGS. 7A-D, which are separate portions of a single page, illustrate exemplary milestones and task level details of Phase 2: “targeting” employed by step 320 of the method of FIG. 3.

FIGS. 8A-D, which are separate portions of a single page, illustrates exemplary milestones and task level details of Phase 3: “Preliminary Due Diligence” employed by step 330 of the method of FIG. 3.

FIGS. 9A-B, which are separate portions of a single page, illustrates exemplary “Due Diligence Issues and Questions” used by the “Management Information Systems” of the “Preliminary Due Diligence” milestones and task levels of FIGS. 8A-D.

FIGS. 10A-D, which are separate portions of a single page, illustrate exemplary milestones and task level details of Phase 4: “Confirmatory Due Diligence” employed by step 340 of the method of FIG. 3.

FIGS. 11A-D, which are separate portions of a single page, illustrates an exemplary “M&A Master Asset Library Inventory” used by the “Confirmatory Due Diligence” milestones and task levels of FIGS. 10A-B.

FIGS. 12A-B, which are separate portions of a single page, illustrates exemplary milestones and task level details of Phase 5: “Transaction Execution/Closing Prep” employed by step 350 of the method of FIG. 3.

FIG. 13 illustrates exemplary steps used by the “Transaction Execution/Closing Prep” milestones and task levels of FIGS. 12A-D.

FIG. 14 illustrates an open due diligence risk, action, issue, decision and escalation log used by the “Transaction Execution/Closing Prep” milestones and task levels of FIGS. 12A-D.

FIGS. 15A-D, which are separate portions of a single page, illustrate exemplary milestones and task level details of Phase 6: “Pre-Close Integration Planning” employed by step 360 of the method of FIG. 3.

FIGS. 16A-D, which are separate portions of a single page, illustrate exemplary milestones and task level details of Phase 7: “Post-Close Integration Planning and Execution” employed by step 370 of the method of FIG. 3.

FIGS. 17A-D, which are separate portions of a single page, illustrate 10 exemplary milestones and task level details of Phase 8: “Long-Term Value Creation” employed by step 380 of the method of FIG. 3.

FIG. 18 illustrates an exemplary method of employment of artificial intelligence in conjunction with the method of FIG. 3.

### DETAILED DESCRIPTION

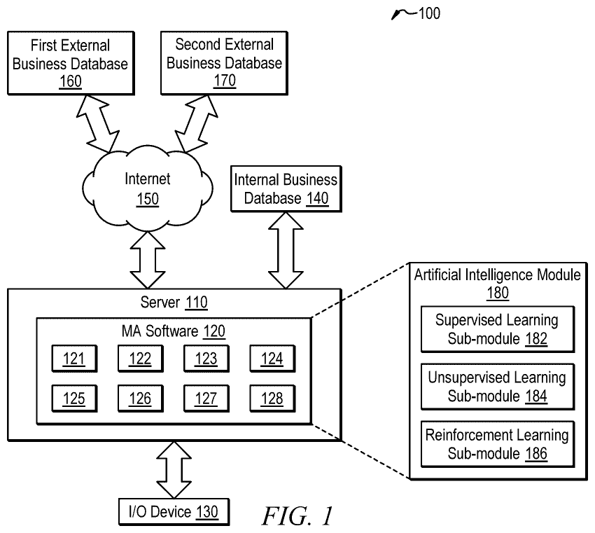

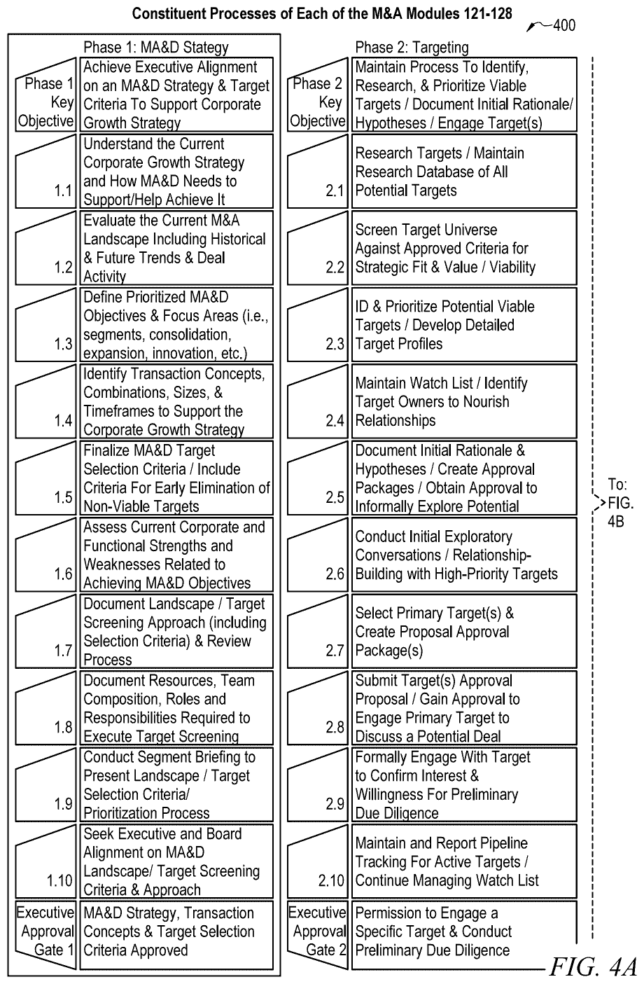

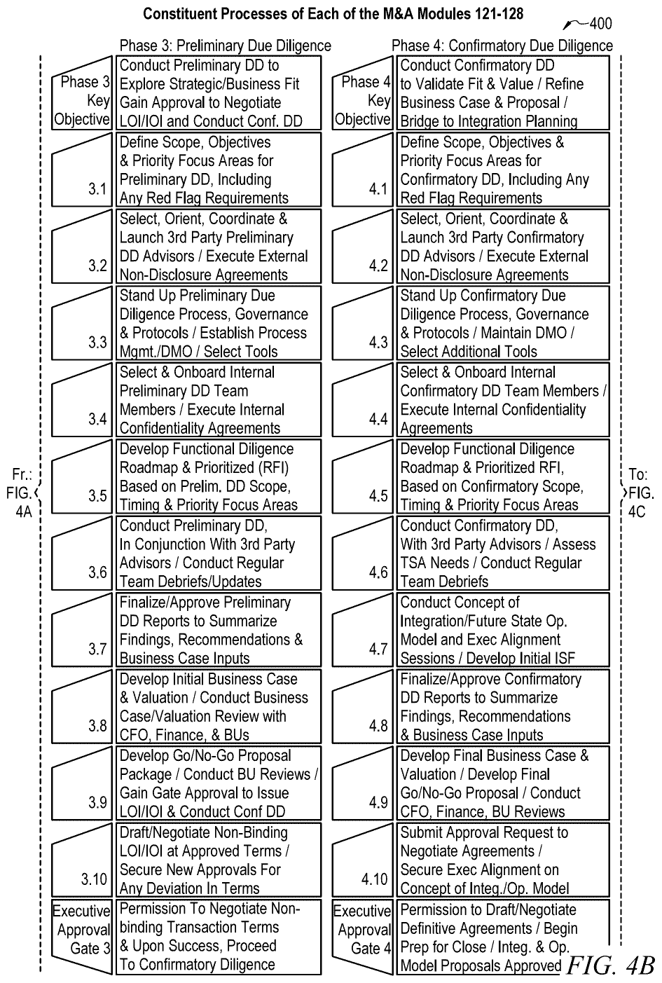

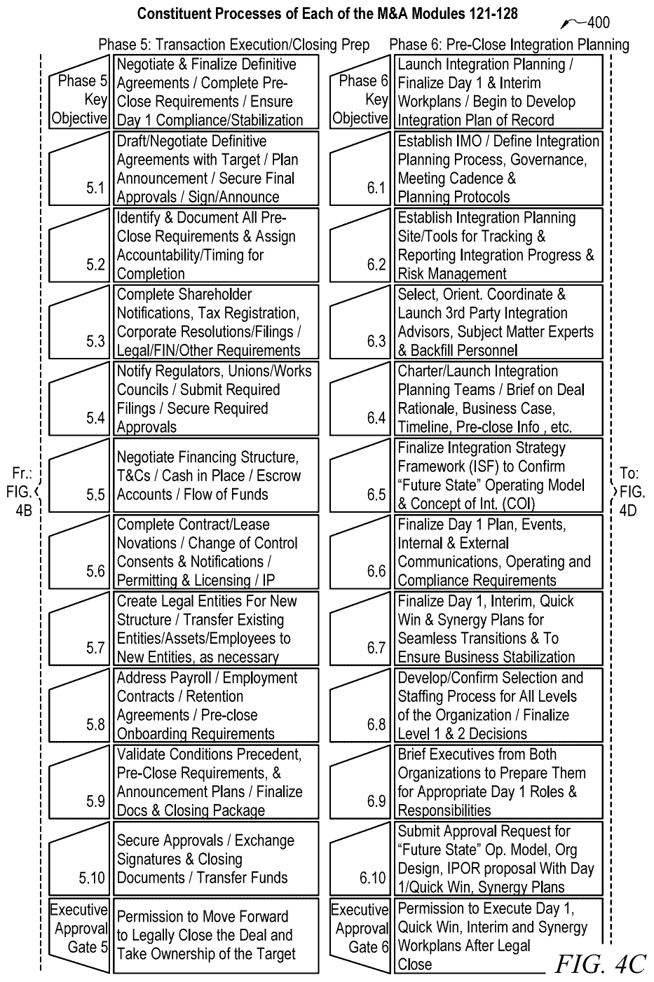

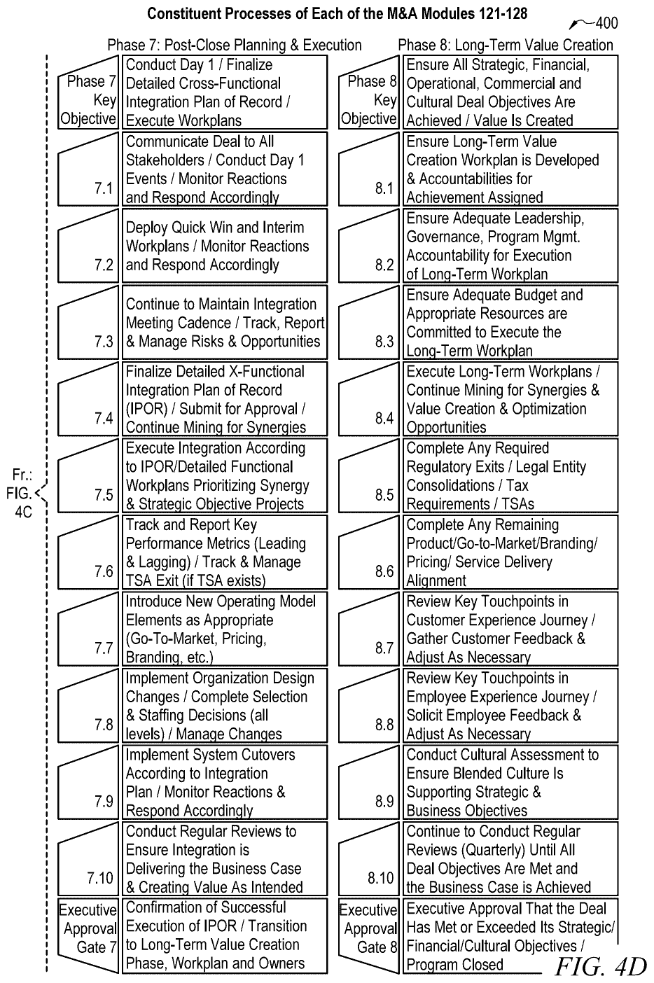

Turning now to FIG. 1, illustrated is a processing system 100 having a server 110. The server includes M&A software 120, which itself includes software modules 121-128: a devising an M&A strategy module 121, a targeting a business for M&A module 122, a conducting preliminary due diligence for M&A module 123, a conducting confirmatory due diligence for M&A module 124, an executing transaction/closing prep module 125, a conduction pre-closing integration planning module 126, a conduction post-closing planning and execution module 127, and a harvesting long-term value creation module 128. Each of these modules will be explained in more detail with their corresponding FIGS. 4A-D to 17A-D below.

The server 110 is further coupled to an input/output (“I/O”) device 130 and an internal business database 140. In some embodiments, the server 110 is further coupled through the Internet 150 to a first external business database 160 and a second business database 170.

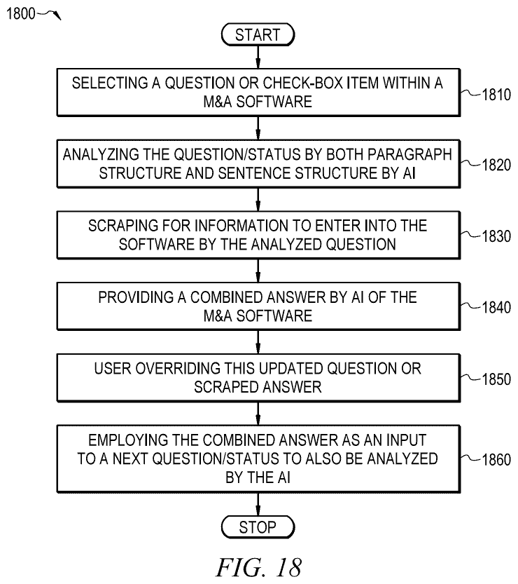

In a further embodiment, the M&A software 120 includes an artificial intelligence module 180 which can include sub-modules 182, 184 and 186, which are then employed by modules 121-128. The artificial intelligence module 180 can include a supervised learning sub-module 182, and/or an unsupervised learning sub-module 184, and/or a reinforcement learning sub-module 186. For more information on these styles of artificial learning processes, please see https://www.tableau.com/data-insights/ai/algorithms “Artificial Intelligence (AI) algorithms: a complete overview as of Jun. 26, 2024, which is hereby incorporated by reference in its entirety. Use of artificial intelligence with the M&A software 120 will be discussed in more detail regarding FIG. 18 below.

Generally, as understood by the present inventor(s), M&A Lifecycle Frameworks are extremely useful for orienting, training and aligning M&A resources. However, they are not a substitute for more detailed M&A Playbooks. Playbooks typically provide additional instructions on specific milestones and tasks, as well as relevant tools and templates required for each phase, including sample workplans that can serve as a baseline or starting point for the functional teams. They also include important reference materials, such as business process and system maps, approval schedules, and prior deal samples. It is typical for Corporate Development, the Integration Management Office (IMO), and individual Functions to each have their own M&A playbooks. However, the M&A Lifecycle Framework of the M&A software 120 serves as a higher-level set of guidelines that ensure alignment across all these teams and functions.

Generally, the M&A software 120 is designed to focus M&A buyers' efforts on the creation of measurable value while preventing many of the problems that historically cause deals to underperform or fail in M&A space. Moreover, the M&A software allows for the benefits of a software manifestation of this M&A framework.

The Lifecycle Framework of the M&A software 100 and its detailed documentation have been designed to provide the practical, foundational considerations and best practices Executives, Corporate Development Leads and Integration Leads need. Because every buyer and deal is unique, the M&A software 120 is designed to be easily adapted to each client's requirements when adopted across the enterprise, the M&A software 120 creates a repeatable business process that is flexible and adaptable enough to apply to all deal types, sizes and levels of complexity.

Generally, the M&A software 120 is designed to cover the entire M&A Lifecycle in eight phases-Strategy through Long-Term Value Creation. Each phase is separated into sub-modules or phases so users of the software can pick up at any point in the deal lifecycle and access the information they need. The standalone phases can also serve as “just-in-time” training modules to brief teams on important focus areas and deliverables as they approach a specific phase.

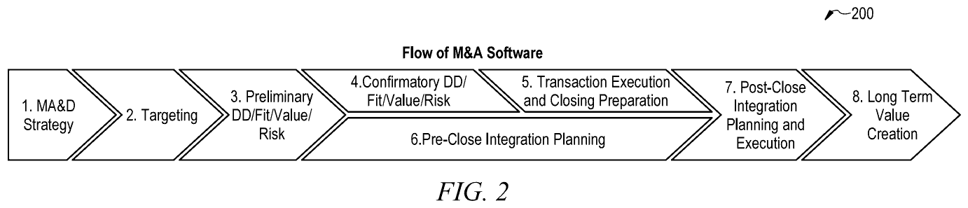

Turning now to FIG. 2, illustrated is a flow 200 of the M&A software employing eight phases, which will employ check lists and decision trees directed towards each phase and configured in the M&A software 120.

Phase 1: “M&A Strategy.” A purpose of phase 1 is to understand and confirm how M&A will be used to achieve the Corporate Strategy; to establish the direction and focus for MA&D efforts in core, adjacencies, and new platforms; and to achieve Executive alignment on the MA&D Objectives and Target Selection Criteria to support Corporate Growth Strategy. This phase is effectuated in module 121 of the system 100.

Phase 2: “Targeting.” A purpose of phase 2 is to identify, research, and prioritize viable Targets; identify high strategic fit Targets and informally build relationships/gauge interest between key Buyer and Seller leaders; Pose Acquisition Rationale/high-level hypotheses for integrating and operating the business to achieve the required strategies & benefits; and Identify Target(s) for pursuit and secure approval to formally engage with Target(s) to confirm interest and conduct Preliminary Diligence. This phase is effectuated in module 122 of the system 100.

Phase 3: “Preliminary Diligence.” A purpose of Phase 3 is to pressure test/validate the Acquisition Rationale/required asset and capability assumptions developed during Phase 1: Targeting; uncover/evaluate “Red Flag” issues/risks, including issues/risks to close, integrate and create value from the deal; document the initial formal hypotheses on how the business would be integrated and operated; document the high-level, top-down Business Case, including synergy opportunities/costs to achieve and integration difficulty/cost; formulate the deal price range and terms the Buyer would be willing to consider; and continue to build the relationship with the Seller, justifying the reasons the Buyer is the best acquirer. This phase is effectuated in module 123 of the system 100.

Phase 4: “Confirmatory Due Diligence.” A purpose of Phase 4 is to further test the Acquisition Rationale and viability of the deal, including identification of “Red Flag” risks; investigate the Target's business, operational and cultural fit; document the final Business Case, including synergies/achievement costs and integration costs; develop final proposals for Business Strategy, Future State Operating Model and Concept of Integration (COI); develop initial Integration Strategy Framework (ISF); and formulate the deal proposal, price range/terms of the Definitive Agreements, including Transition Services Agreements, where required. This phase is effectuated in module 124 of the system 100.

Phase 5: “Transaction Execution and Closing Preparation.” A purpose of Phase 5 is to complete all requirements to Sign/Close the transaction and take legal, financial, and operational control at Close. Corp Dev and the DMO, with the support of Legal and the required subject matter experts, are responsible for driving and managing the deliverables. This phase is effectuated in module 125 of the system 100.

Phase 6: “Pre-Close Integration Planning.” A purpose of Phase 6 is to formally launch Integration Planning; finalize Day 1 Plans; finalize Interim Transition Plans (90-120 Day Plans) to stabilize the business; finalize Quick Win Plans; begin development of the Integration Plan of Record (IPOR); and complete as much pre-close integration planning as time and access allows. This phase is effectuated in module 126 of the system 100.

Phase 7: “Post-Close Planning and Execution.” A purpose of Phase 7 is to execute the Day 1 Plan; execute the Interim Transition (90-120 Day) Plan; execute Quick Wins; continue to develop detailed workplans that cover milestones and tasks beyond the initial transition period; finalize and execute the Integration Plan of Record (IPOR); and begin realizing the Synergies and Business Case. This phase is effectuated in module 127 of the system 100.

Phase 8: “Long Term Value Creation.” A purpose of Phase 8 is to conduct a smooth and seamless handoff from integration resources to the business resources ultimately accountable for running the acquired business; ensure that any longer-term actions required to realize full value from the deal are identified and assigned to ensure accountability for completion; and ensure the acquiring business has adequate leadership, resources and budget to complete their assigned integration-related actions successfully. This phase is effectuated in module 128 of the system 100.

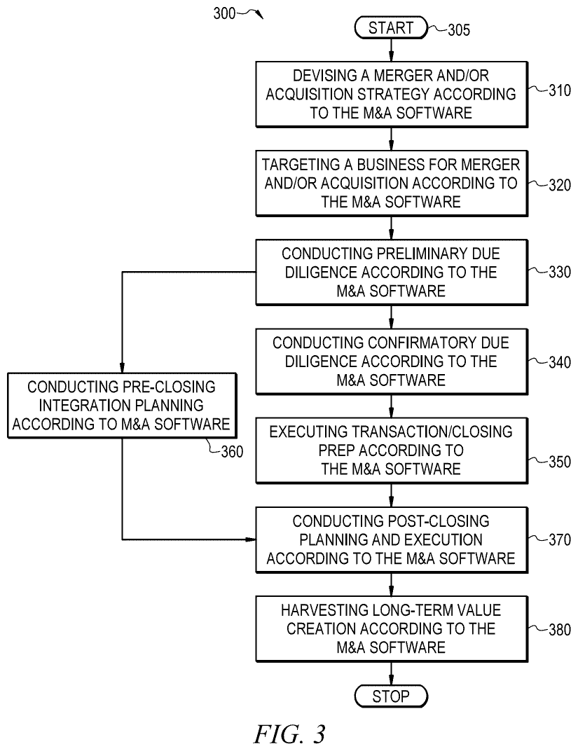

Turning now to FIG. 3, illustrated is method 300 for employment of the M&A software 120.

After a start step 305, the method 300 advances to a devising a merger and/or acquisition strategy according to the M&A software 120 in a step 310 (“Phase 1.”) The method 300 advances to a step 320.

In step 320, a targeting of a business for merger and/or acquisition according to the M&A software 120 is performed (“Phase 2.”) The method 300 advances to a step 330.

In a step 330, a conducting of a preliminary due diligence according to the M&A software 120 is performed (“Phase 3.”) The method 300 then advances in parallel to a step 340 and a step 360.

In a step 340, a conducting of a confirmatory due diligence according to the M&A software 120 is performed (“Phase 4”). The method 300 then advances to a step 360.

In step 350, an executing of a transaction/closing preparation according to the M&A software 120 is performed. (“Phase 5”).

In a step 340, a conducting of pre-closing integration and planning according to the M&A software 120 is performed (“Phase 6.”) Both the step 340 and the step 360 of the method 300 advance to a step 370.

In step 370, a conducting of post-closing planning and execution according to the M&A software is performed. (“Phase 7.”) The method 300 then advances to a step 380.

In step 380, a harvesting of long-term value creation according to the M&A software is performed (“Phase 8”). The method 300 then stops.

Turning now to FIGS. 4A-D, which are separate parts of a single page, illustrated are exemplary constituent processes of the M&A modules 121-128 as correlated to Phases 1-8 configured according to the principles of the present application, as shall be discussed in more detail, below.

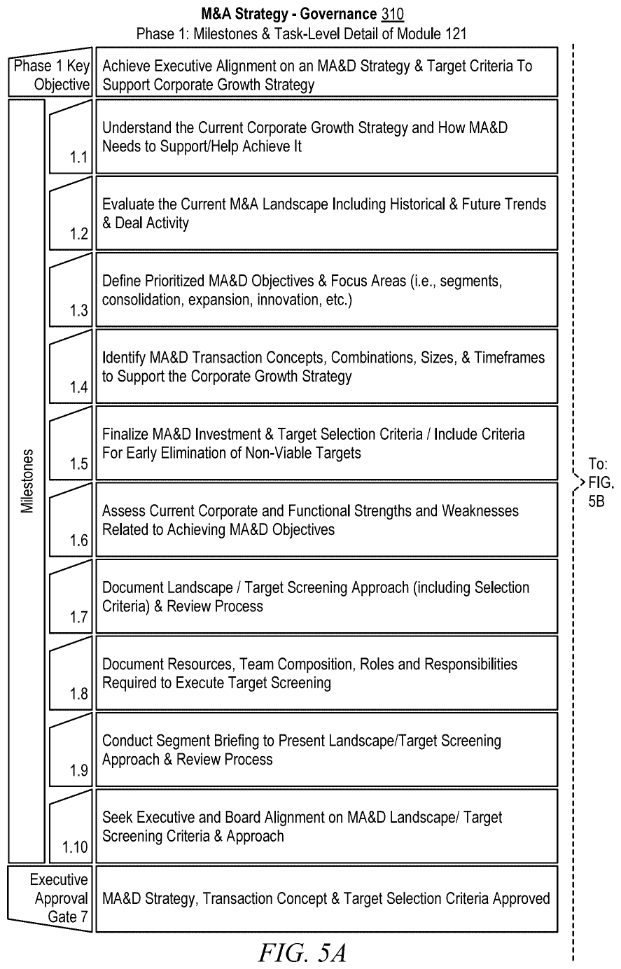

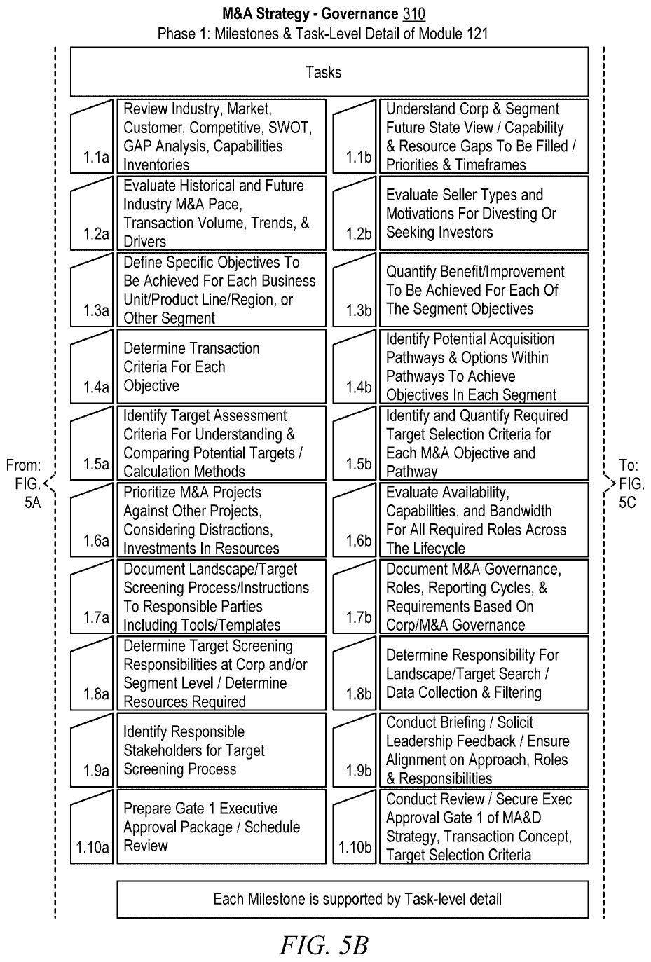

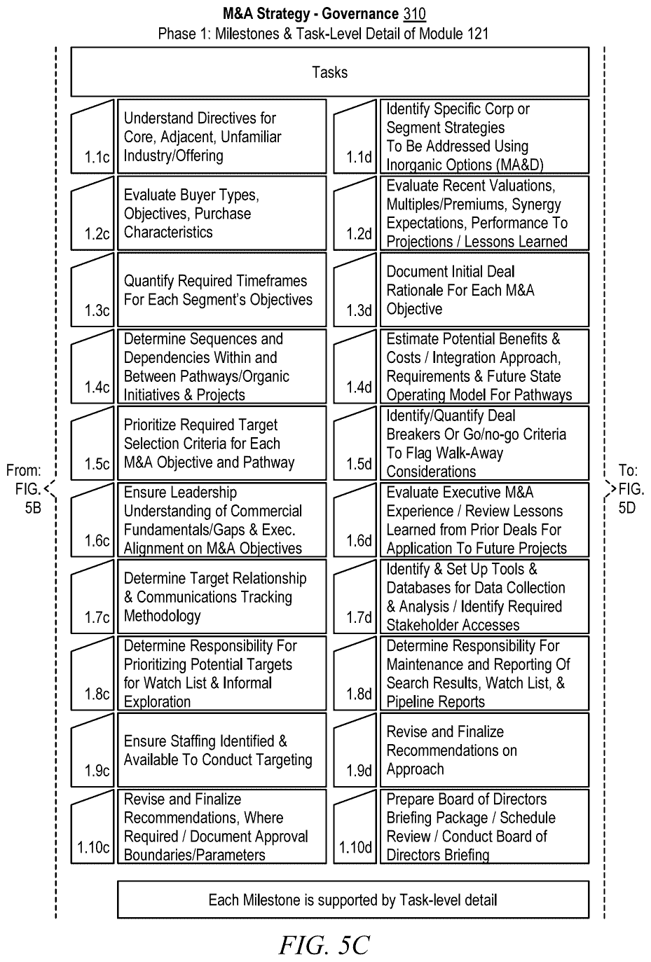

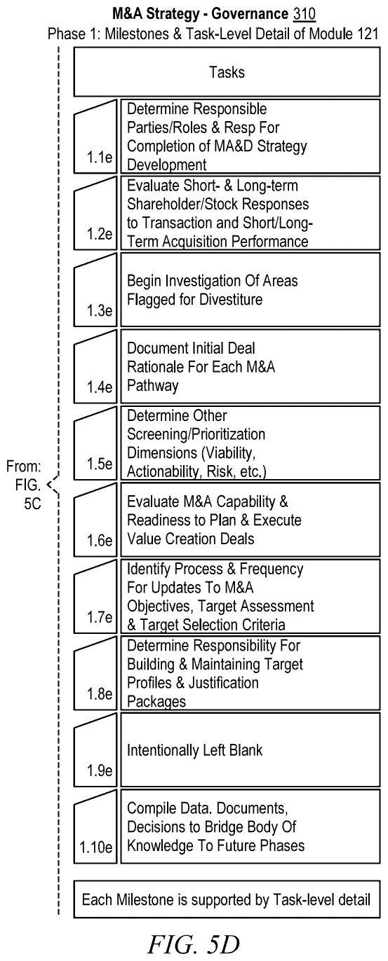

Turning now to FIGS. 5A-D, which are separate parts of a single page, illustrated are milestones and task-level detailed processes of module 121. Each milestone is supported by task-level details which are invoked by the processes. The milestones include: 1.1 Understand the Current Corporate Growth Strategy and How MA&D Needs to Support/Help Achieve It; 1.2 Evaluate the Current M&A Landscape Including Historical & Future Trends & Deal Activity; 1.3 Define Prioritized M&A Objectives & Focus Areas (i.e., segments, consolidation, expansion, innovation, etc.); 1. Identify M&A Transaction Concepts, Combinations, Sizes, & Timeframes to Support the Corporate Growth Strategy; 1.5 Finalize M&A Investment & Target Selection Criteria/Include Criteria for Early Elimination of Non-Viable Targets; 1.6 Assess Current Corporate and Functional Strengths and Weaknesses Related to Achieving M&A Objectives; 1.7 Document Landscape/Target Screening Approach (including Selection Criteria) & Review Process; 1.8 Document Resources, Team Composition, Roles and Responsibilities Required to Execute Target Screening; 1.9 Conduct Segment Briefing to Present Landscape/Target Screening Approach & Review Process; and 1.10 Seek Executive and Board Alignment on MA&D Landscape/Target Screening Criteria & Approach; and approving MA&D Strategy, Transaction Concept & Target Selection Criteria.

Furthermore, each of these milestones each include a plurality of task-level details, e.g., for Phase 1.1:1.1a Review industry, market, customer, competitive, SWOT, gap analysis capabilities/inventories, 1.1b Understand corporate and segment future state view/capability and rouse gaps to be filled/priority and timeframes; 1.1c Understand directives for core/adjacent/unfamiliar industry/offering.

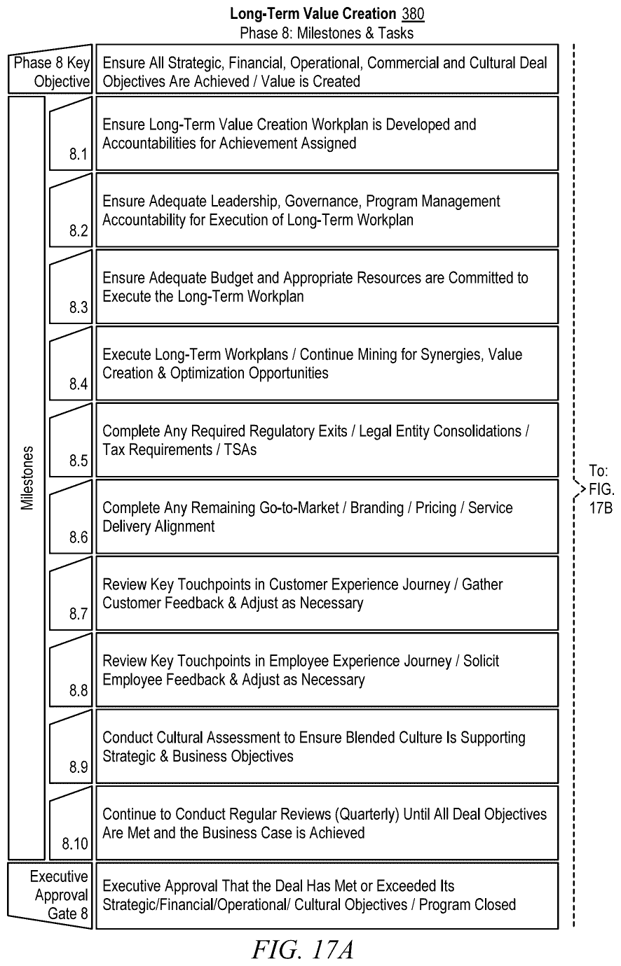

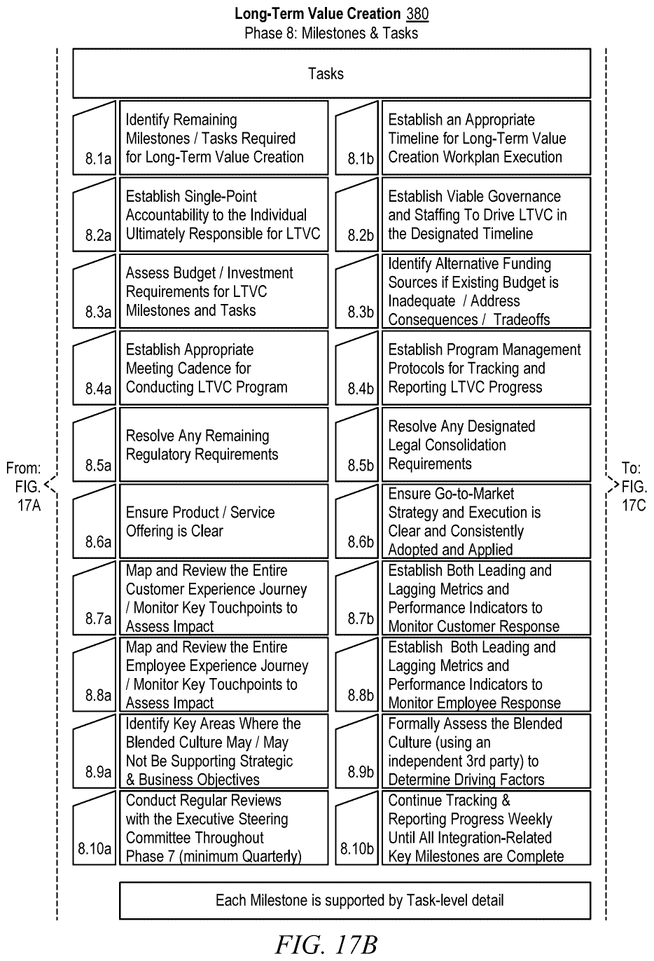

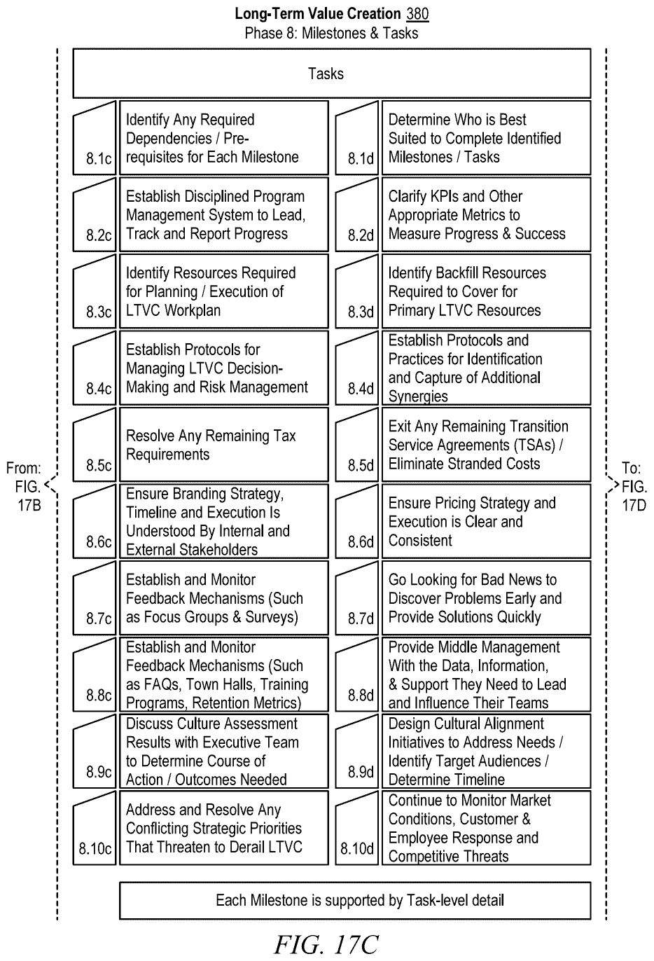

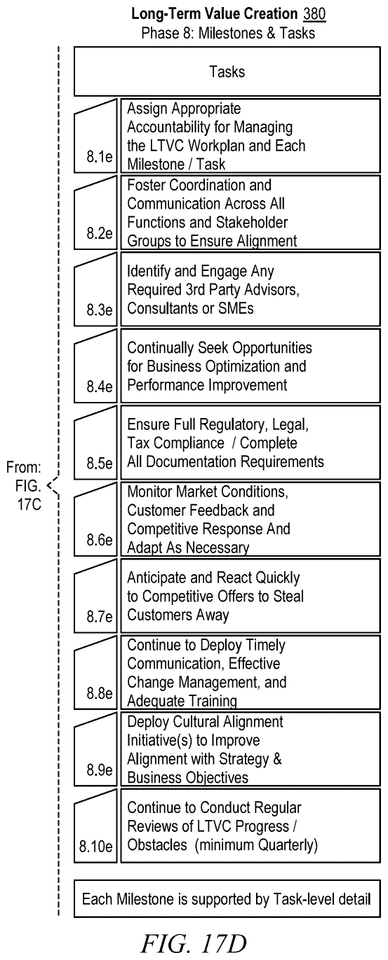

FIGS. 5A-D to FIGS. 17A-D provide additional information regarding task-level details of their respective phases and milestones for this Phase and the remaining Phases.

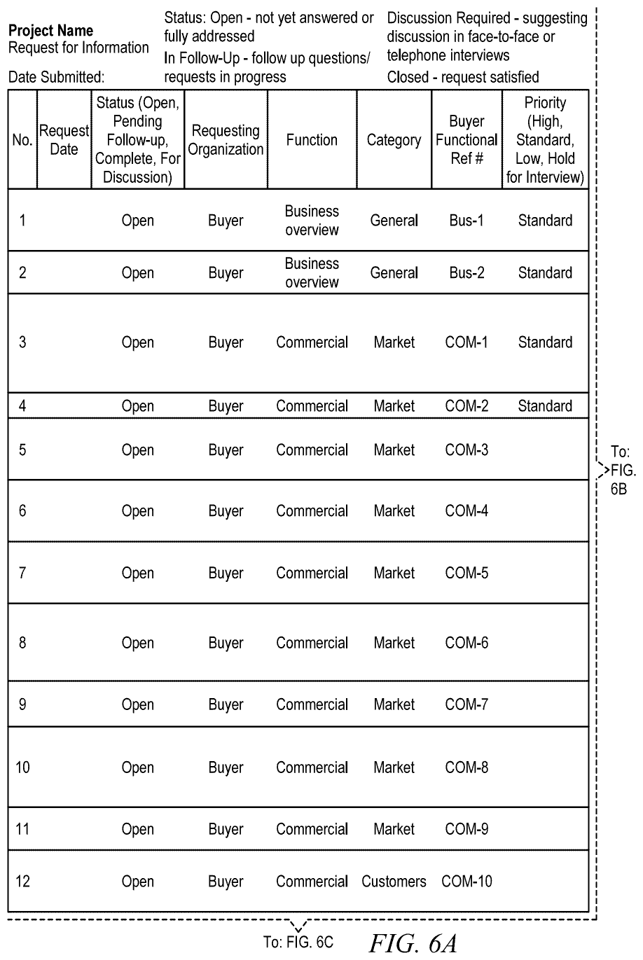

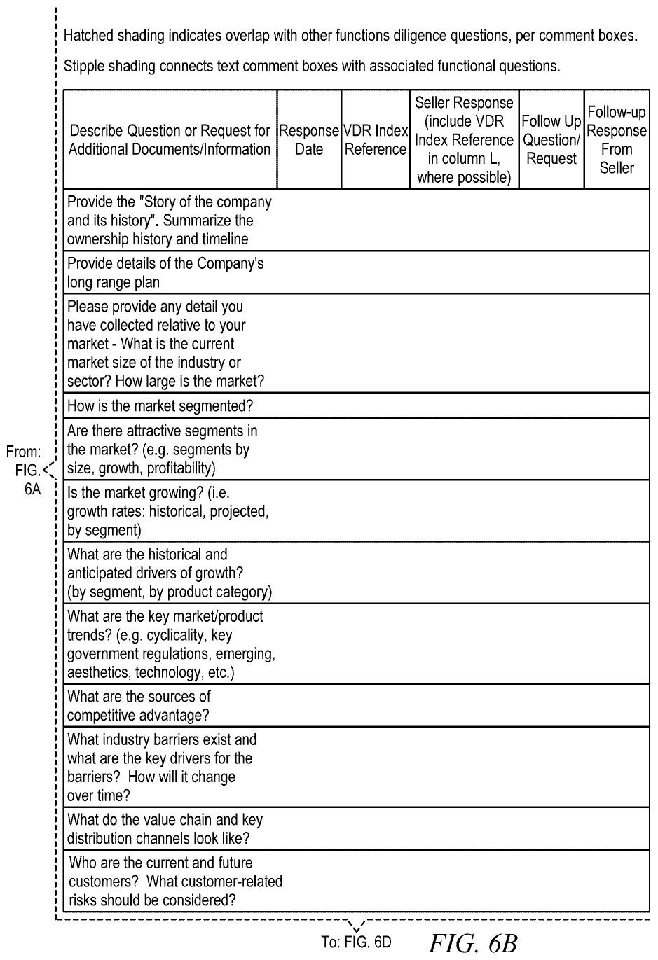

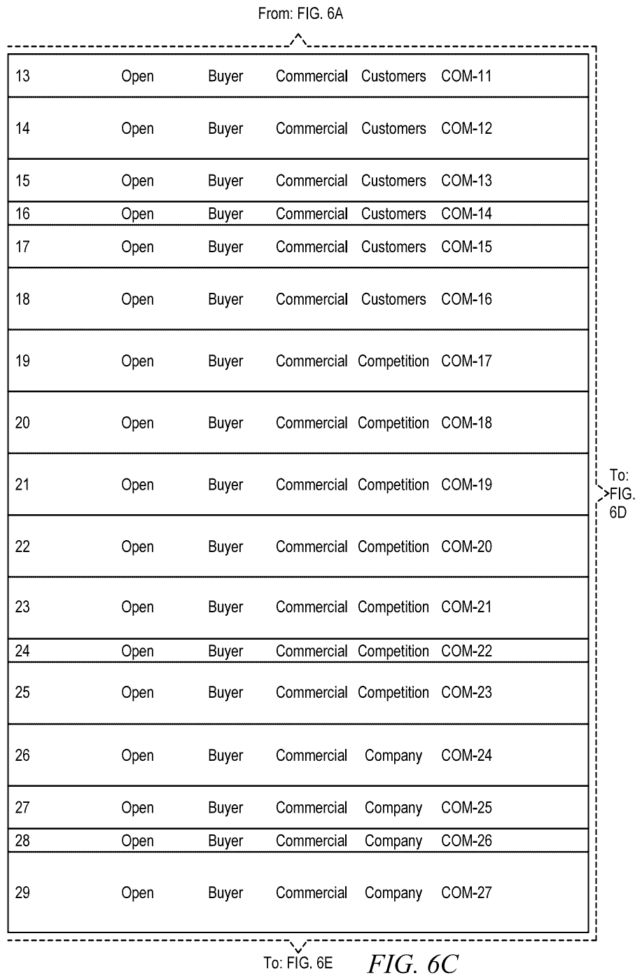

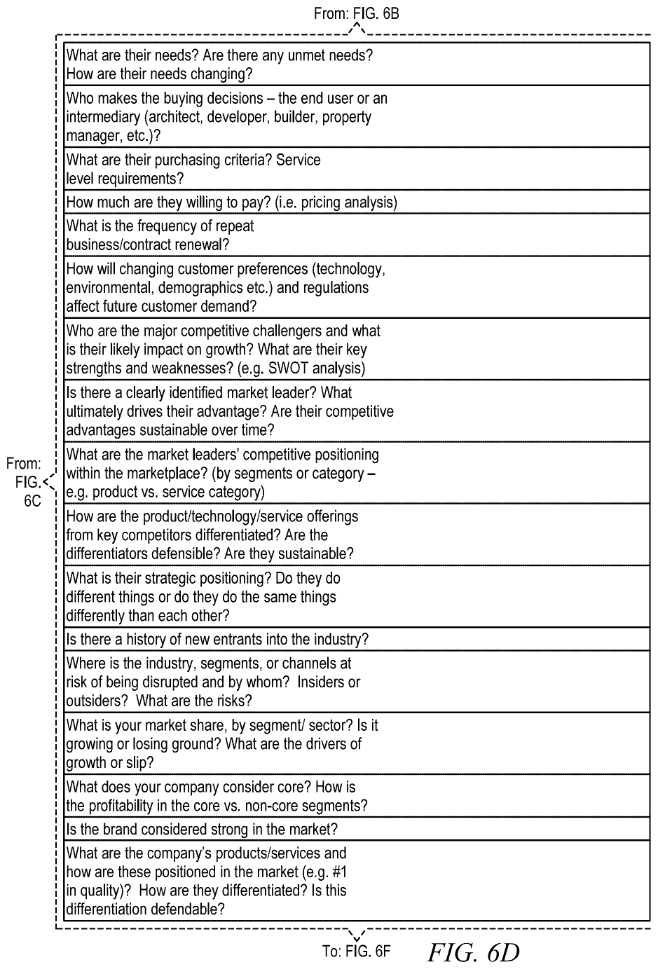

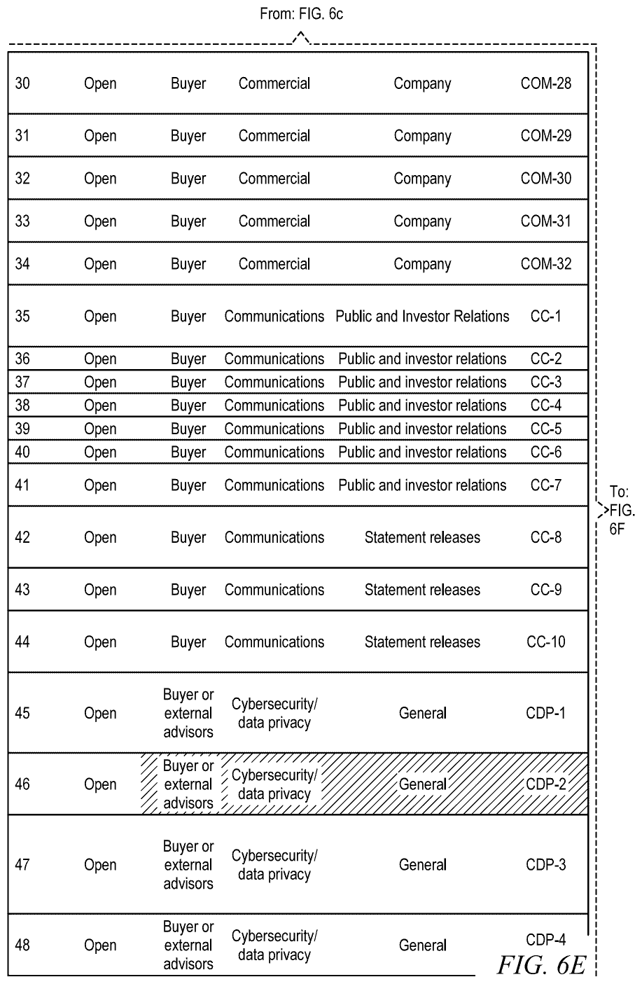

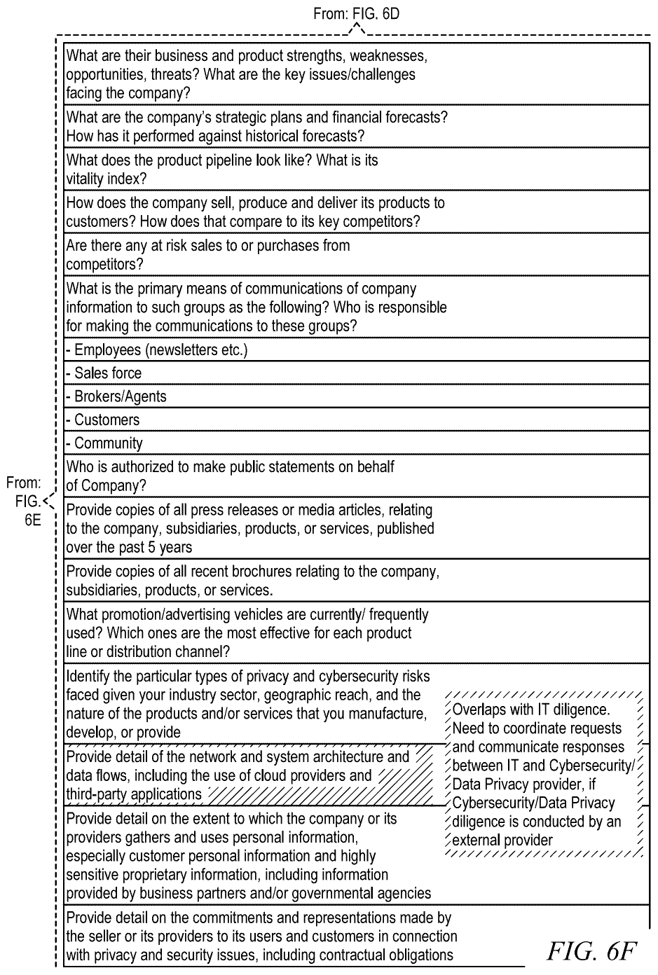

Turning now to FIGS. 6AF, which are separate parts of a single page, illustrated is a first page of exemplary checklist items employed by step 310 of the method of FIG. 3. These checklists can correlate to the various task level details of FIGS. 5A-D.

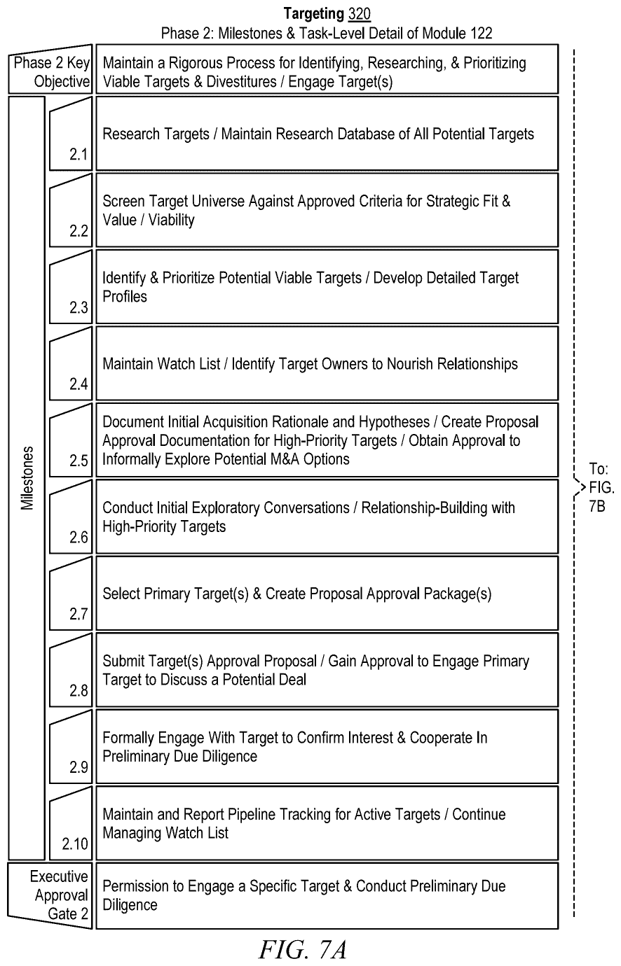

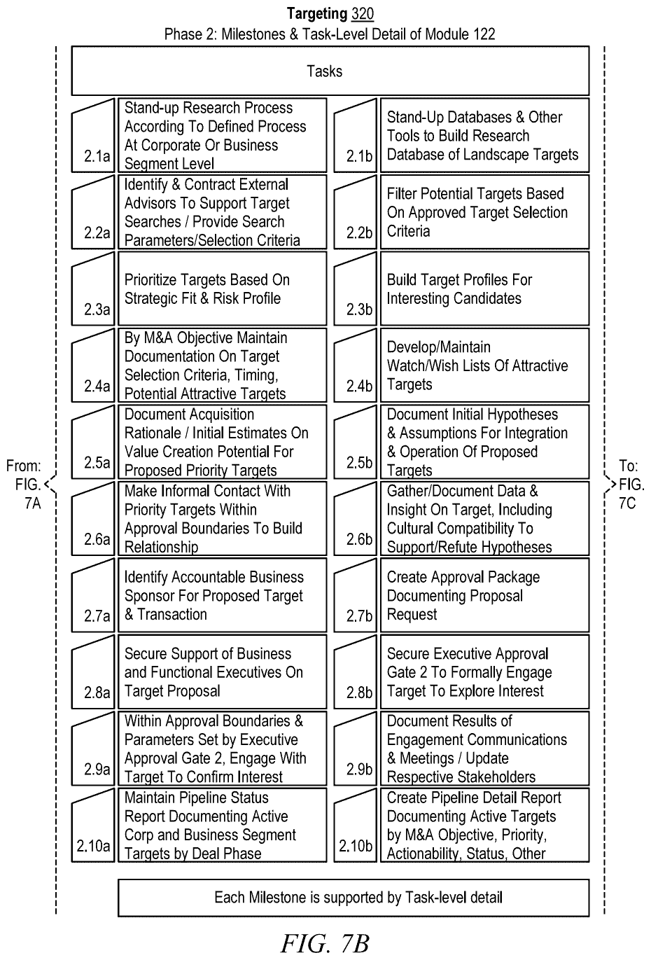

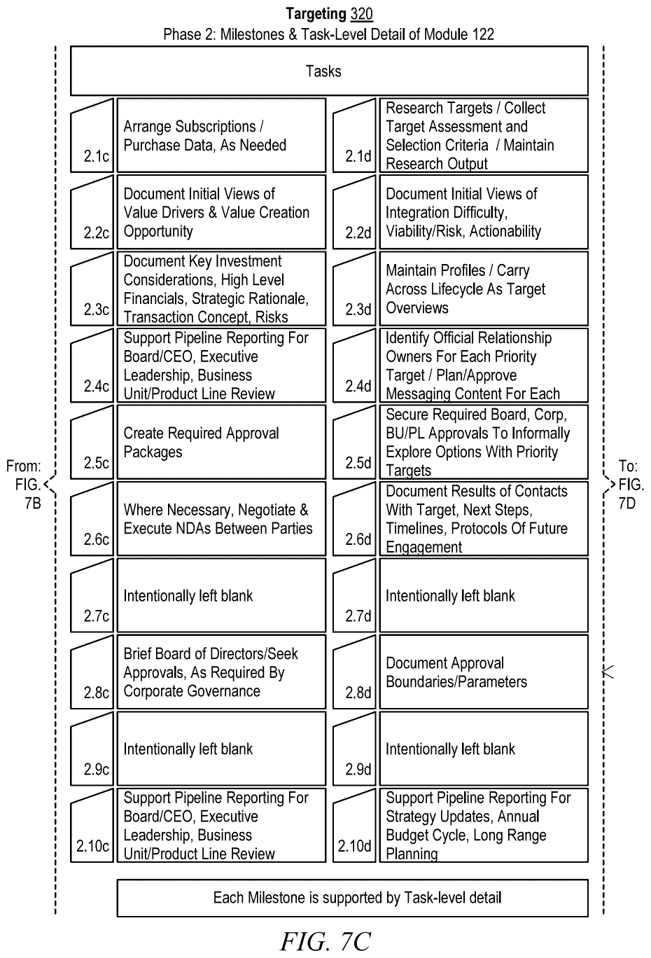

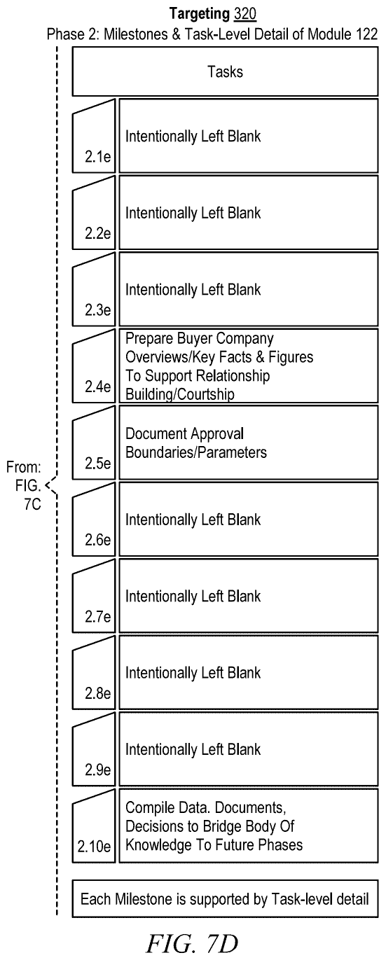

Turning now to FIGS. 7A-D, illustrated are milestones and task-level detail processes of module 122. Each milestone is supported by task-level details which are invoked by the processes. The milestones include: 2.1 Research Targets/Maintain Research Database of All Potential Targets; 2.2 Screen Target Universe Against Approved Criteria for Strategic Fit & Value/Viability; 2.3 Identify & Prioritize Potential Viable Targets/Develop Detailed Target Profiles; 2.4 Maintain Watch List/Identify Target Owners to Nourish Relationships; 2.5 Document Initial Acquisition Rationale and Hypotheses/Create Proposal Approval Documentation for High-Priority Targets/Obtain Approval to Informally Explore Potential M&A Options; 2.6 Conduct Initial Exploratory Conversations/Relationship-Building with High-Priority Targets; 2.7 Select Primary Target(s) & Create Proposal Approval Package(s); Submit Target(s) Approval Proposal/Gain Approval to Engage Primary Target to Discuss a Potential Deal; 2.8 Submit Target(s) Approval Proposal/Gain Approval to Engage Primary Target to Discuss a Potential Deal; 2.9 formally Engage With Target to Confirm Interest & Cooperate In Preliminary Due Diligence; 2.10 Maintain and Report Pipeline Tracking for Active Targets/Continue Managing Watch List Permission to Engage a Specific Target & Conduct Preliminary Due Diligence.

Each of these milestones has its own corresponding plurality of task-level details, as illustrated. Moreover, each of these task-level details has its own corresponding checklist of items, analogous to FIGS. 6A-F.

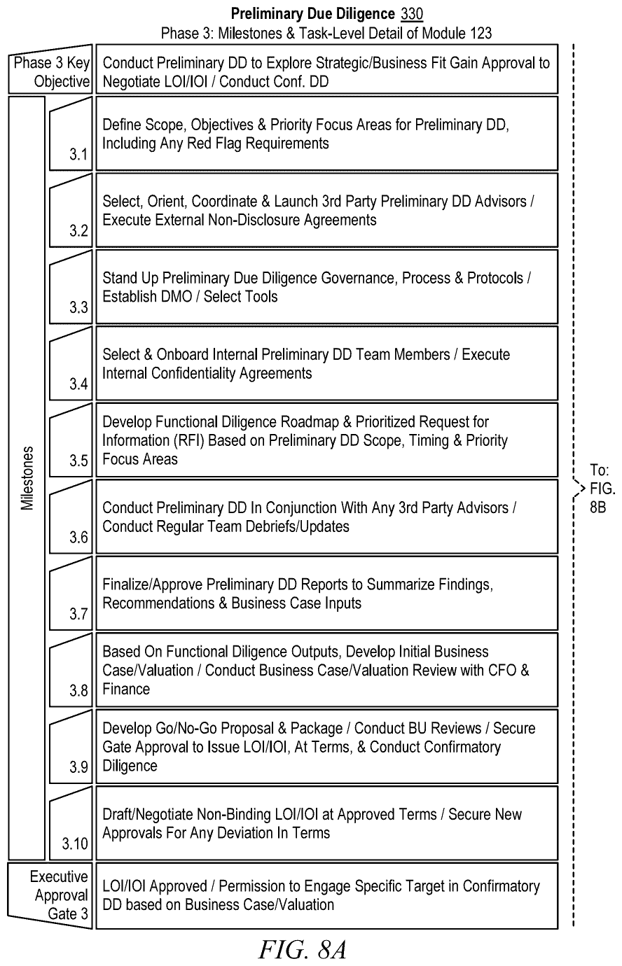

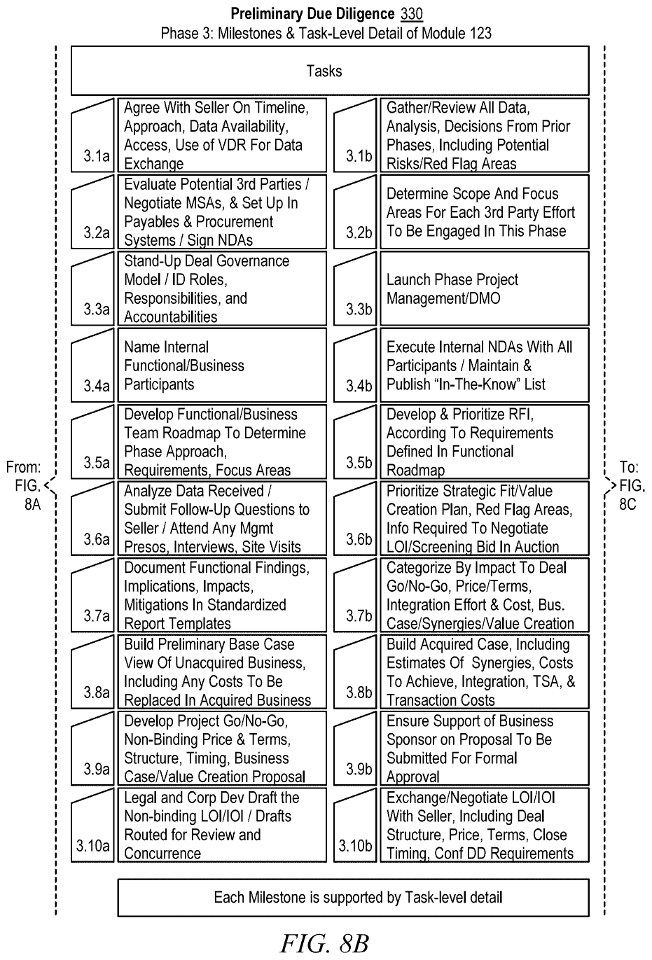

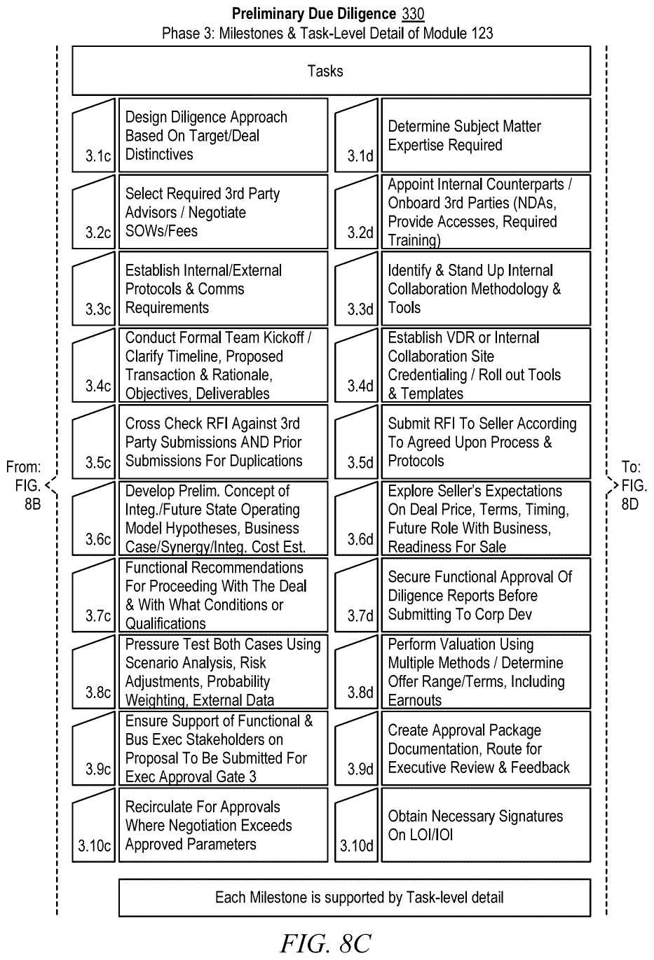

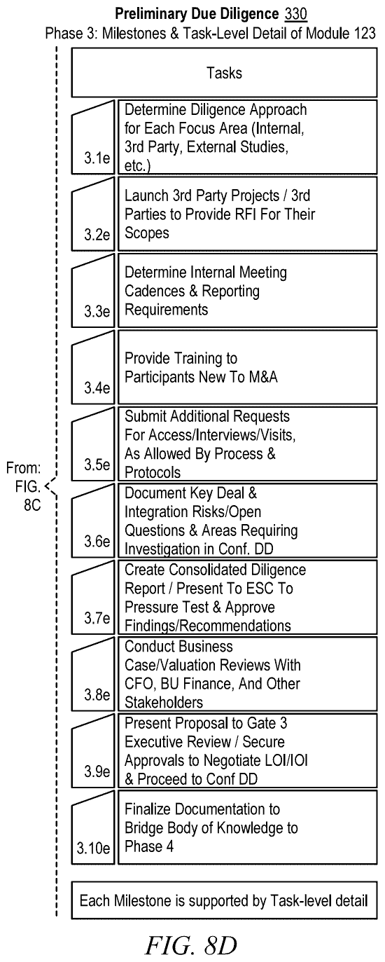

Turning now to FIGS. 8A-D, illustrated are milestones and task-level detail processes of module 123. Each milestone is supported by task-level details which are invoked by the processes. The milestones include: 3.1 Define Scope, Objectives & Priority Focus Areas for Preliminary DD, Including Any Red Flag Requirements; 3.2 Select, Orient, Coordinate & Launch 3rd Party Preliminary DD Advisors/Execute External Non-Disclosure Agreements; 3.3 Stand Up Preliminary Due Diligence Governance, Process & Protocols/Establish DMO/Select Tools; 3.4 Select & Onboard Internal Preliminary DD Team Members/Execute Internal Confidentiality Agreements; 3.5 Develop Functional Diligence Roadmap & Prioritized Request for Information (RFI) Based on Preliminary DD Scope, Timing & Priority Focus Areas; 3.6 Conduct Preliminary DD In Conjunction With Any 3rd Party Advisors; 3.6 Conduct Regular Team Debriefs/Updates; 3.7 Finalize/Approve Preliminary DD Reports to Summarize Findings, Recommendations & Business Case Inputs; 3.8 Based On Functional Diligence Outputs, Develop Initial Business Case/Valuation/Conduct Business Case/Valuation Review with CFO & Finance; 3.9 Develop Go/No-Go Proposal & Package/Conduct BU Reviews/Secure Gate Approval to Issue LOI/IOI, At Terms, & Conduct Confirmatory Diligence; and 3.10 Draft/Negotiate Non-Binding LOI/IOI at Approved Terms/Secure New Approvals For Any Deviation In Terms LOI/IOI Approved/Permission to Engage Specific Target in Confirmatory DD based on Business Case/Valuation.

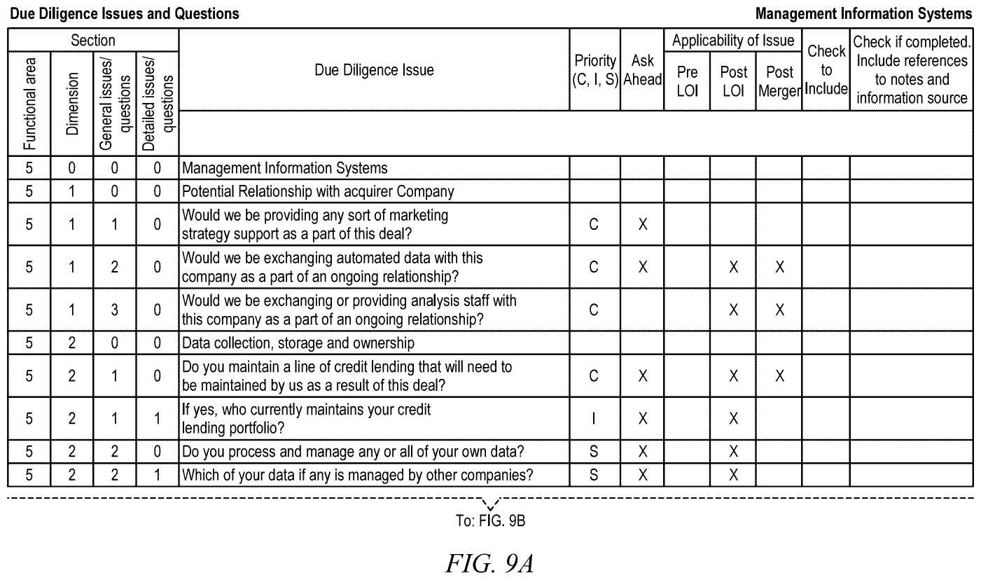

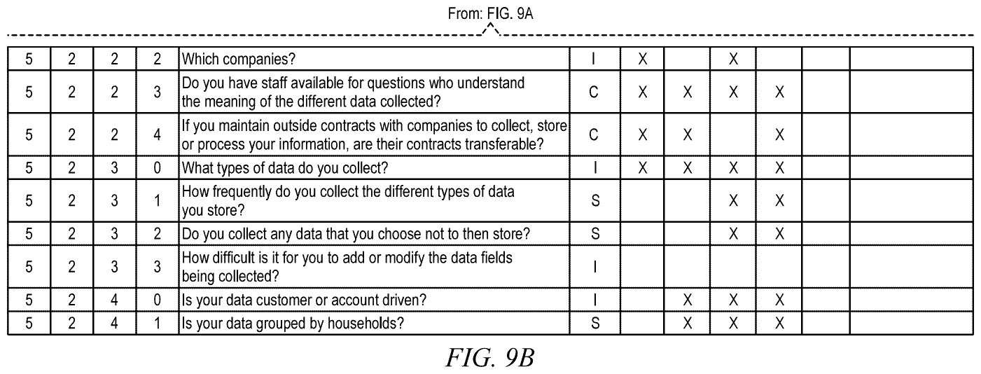

Each of these milestones has its own corresponding plurality of task-level details, as illustrated. Moreover, each of these task-level details has its own corresponding checklist of items, a subset of which is illustrated in FIGS. 9A-B.

Turning now to FIGS. 9A-B, illustrated is a first page of a “due diligence issues checklist items employed by step 330 of the method of FIG. 3. These checklists can correlate to the various task level details of FIGS. 8A-D.

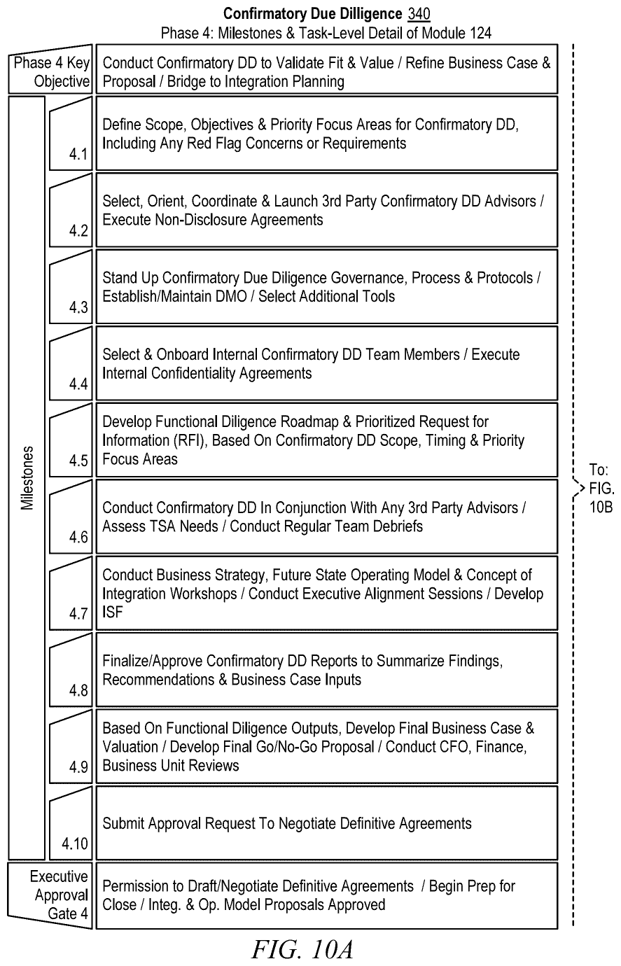

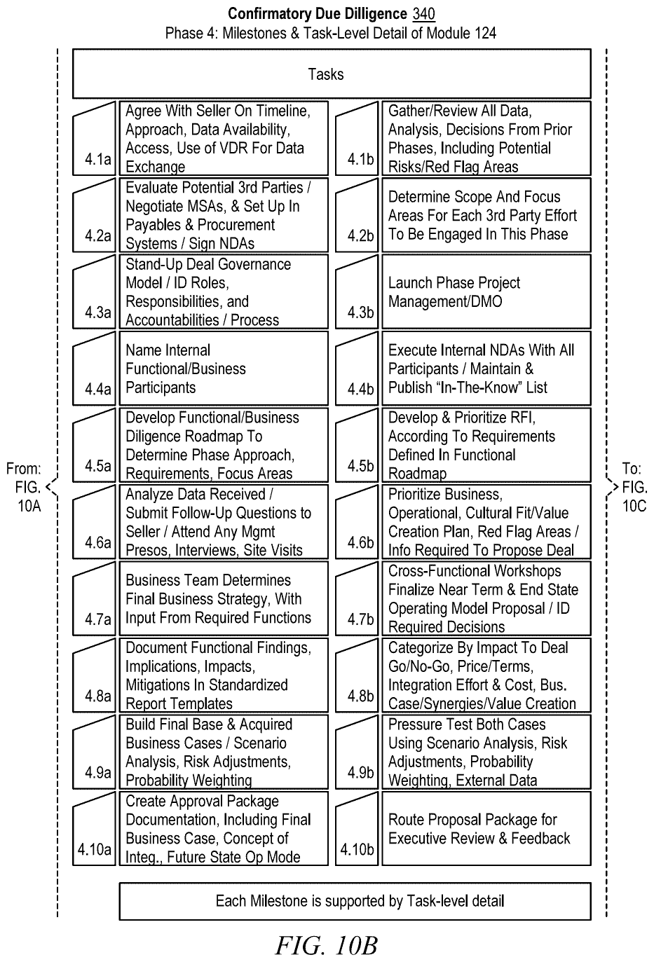

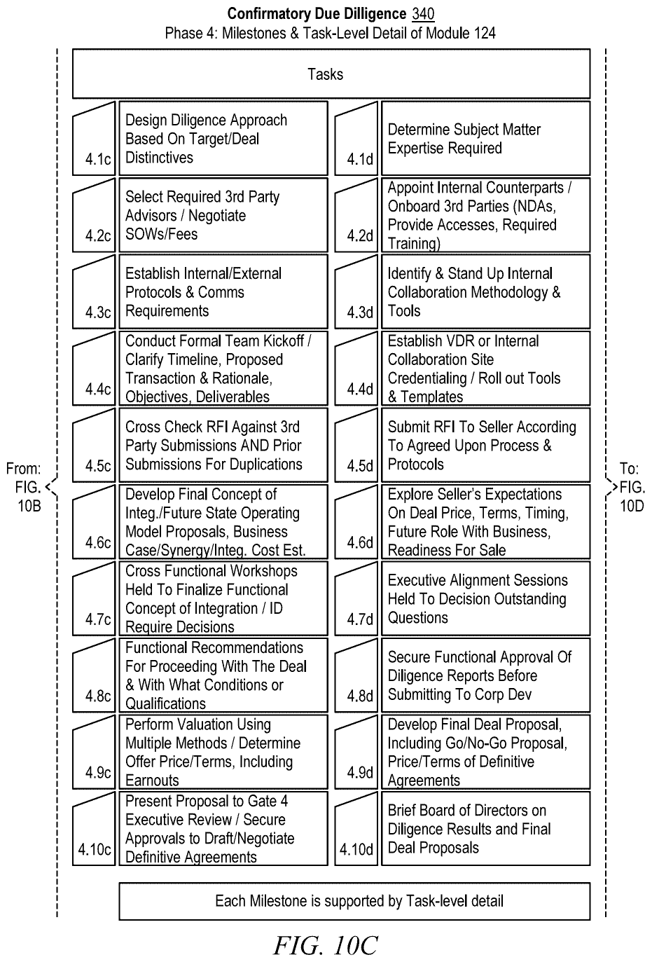

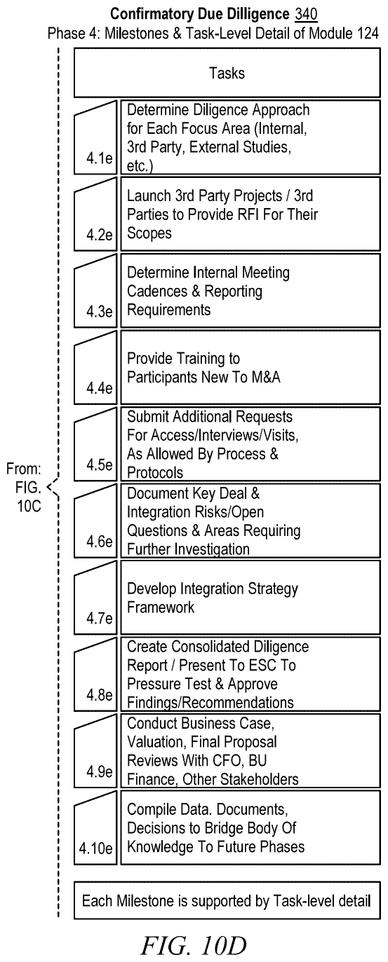

Turning now to FIGS. 10A-D, illustrated are milestones and task-level detail processes of module 124. Each milestone is supported by task-level details which are invoked by the processes. The milestones include: 4.1 Define Scope, Objectives & Priority Focus Areas for Confirmatory DD, Including Any Red Flag Concerns or Requirements; 4.2 Select, Orient, Coordinate & Launch 3rd Party Confirmatory DD Advisors/Execute Non-Disclosure Agreements; 4.3 Stand Up Confirmatory Due Diligence Governance, Process & Protocols/Establish/Maintain DMO/Select Additional Tools; 4.4 Select & Onboard Internal Confirmatory DD Team Members/Execute Internal Confidentiality Agreements; 4.5 Develop Functional Diligence Roadmap & Prioritized Request for Information (RFI), Based On Confirmatory DD Scope, Timing & Priority Focus Areas; 4.6 Conduct Confirmatory DD In Conjunction With Any 3rd Party Advisors/Assess TSA Needs/Conduct Regular Team Debriefs; 4.7 Conduct Business Strategy, Future State Operating Model & Concept of Integration Workshops/Conduct Executive Alignment Sessions/Develop ISF; 4.8 Finalize/Approve Confirmatory DD Reports to Summarize Findings, Recommendations & Business Case Inputs; 4.9 Based On Functional Diligence Outputs, Develop Final Business Case & Valuation/Develop Final Go/No-Go Proposal/Conduct CFO, Finance, Business Unit Reviews; 4.10 Submit Approval Request To Negotiate Definitive Agreements Permission to Draft/Negotiate Definitive Agreements/Begin Prep for Close/Integration. & Op. Model Proposals Approved.

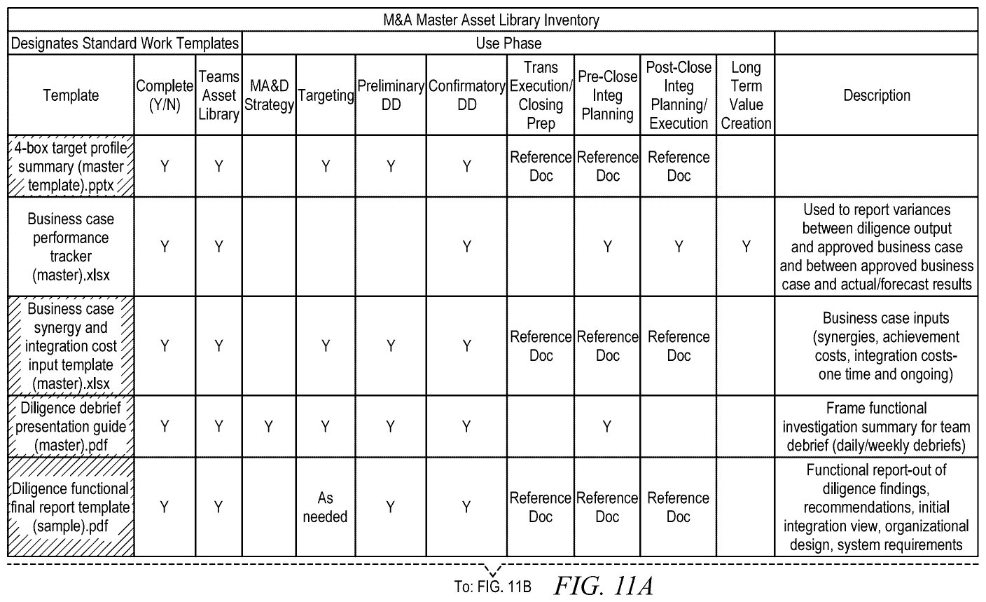

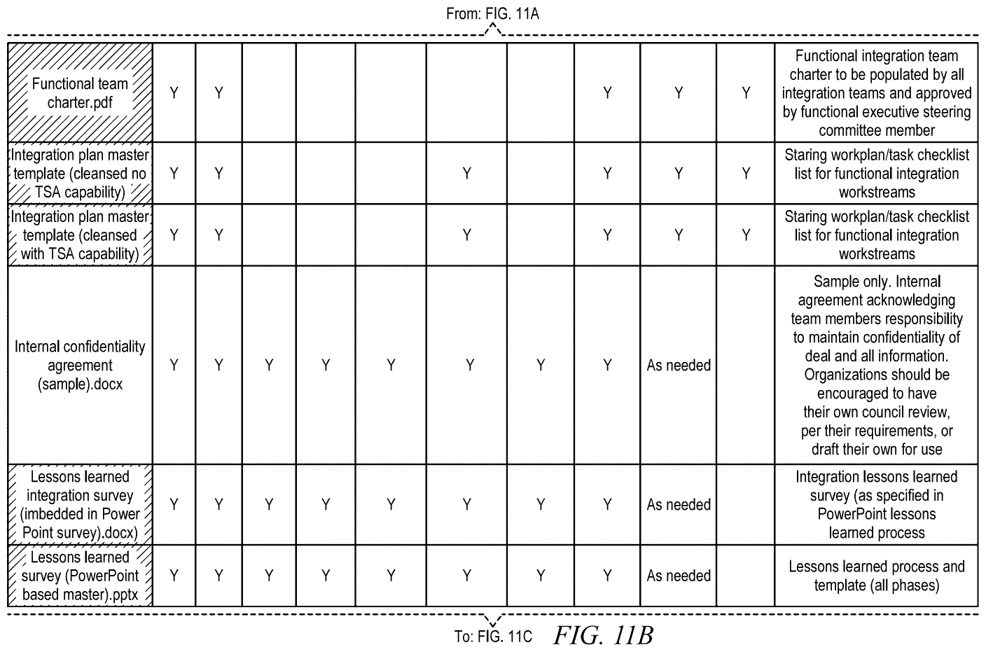

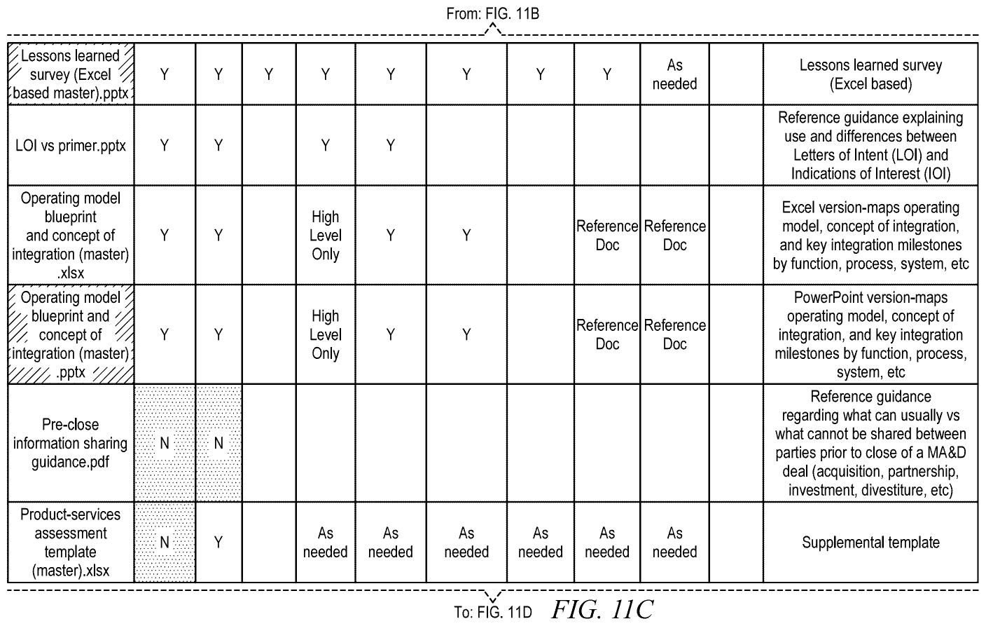

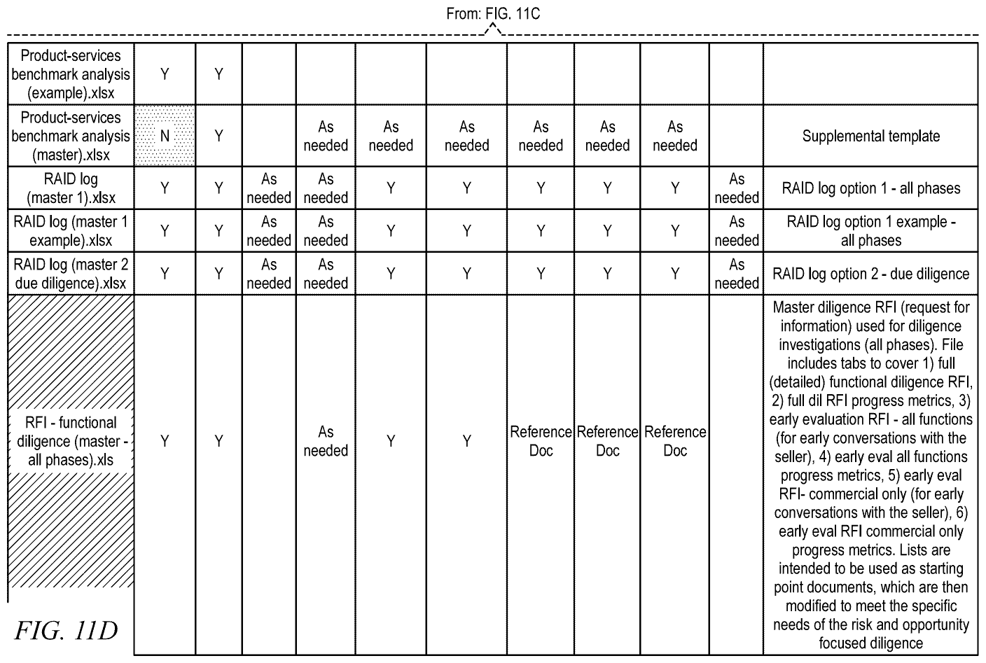

Each of these milestones has its own corresponding plurality of task-level details, as illustrated. Moreover, each of these task-level details has its own corresponding checklist of items, a subset of which is illustrated in FIGS. 11A-D.

Turning now to FIGS. 11A-D, illustrated is exemplary “M&A Master Asset Library Inventory” used by the “Confirmatory Due Diligence” milestones and task levels of FIGS. 10A-D.

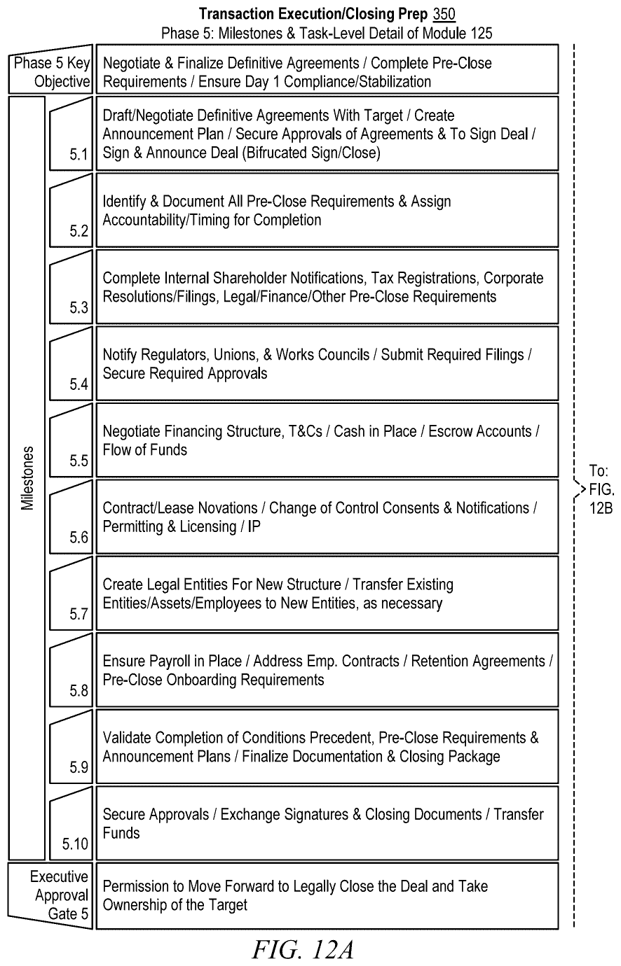

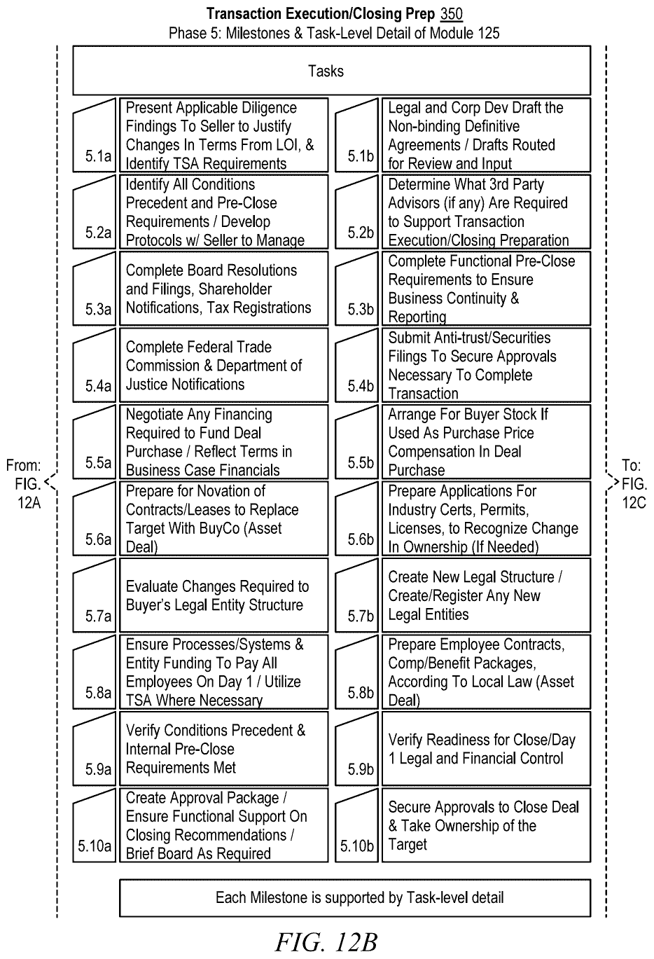

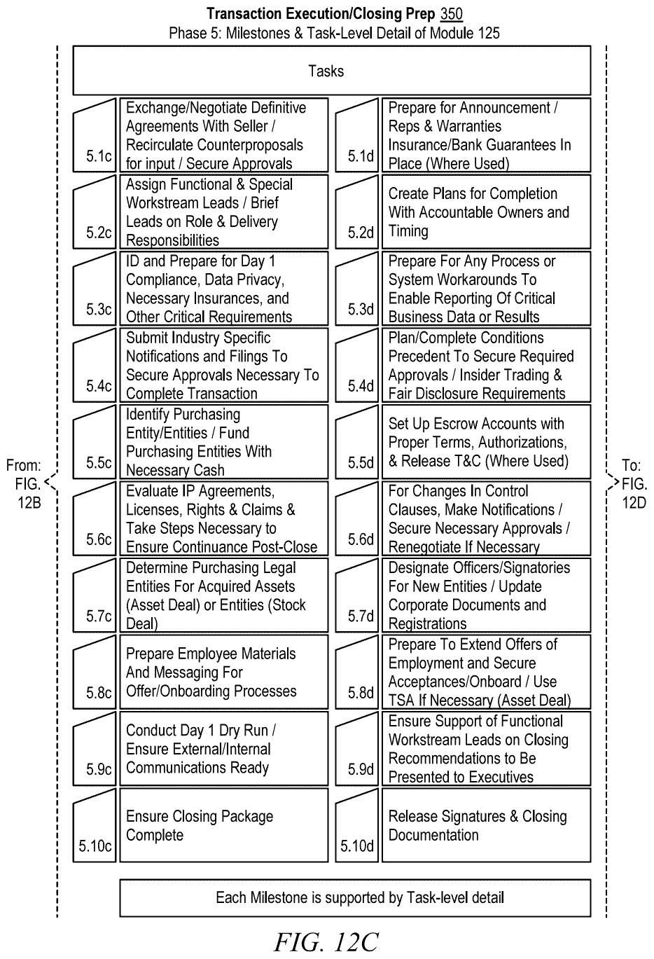

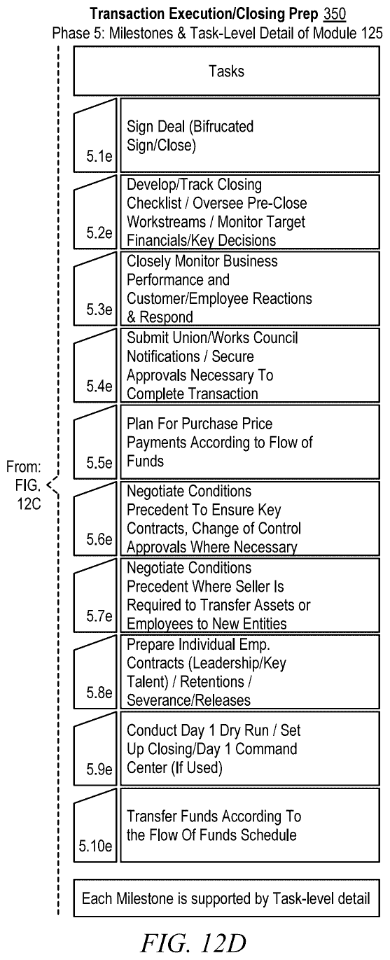

Turning now to FIGS. 12A-D, illustrated are milestones and task-level detail processes of module 125. Each milestone is supported by task-level details which are invoked by the processes. The milestones include: 5.1 Draft/Negotiate Definitive Agreements With Target/Create Announcement Plan/Secure Approvals of Agreements & To Sign Deal/Sign & Announce Deal (Bifurcated Sign/Close); 5.2 Identify & Document All Pre-Close Requirements & Assign Accountability/Timing for Completion; 5.3 Complete Internal Shareholder Notifications, Tax Registrations, Corporate Resolutions/Filings, Legal/Finance/Other Pre-Close Requirements; 5.4 Notify Regulators, Unions, & Works Councils/Submit Required Filings/Secure Required Approvals; 5.5 Negotiate Financing Structure, T&Cs/Cash in Place/Escrow Accounts/Flow of Funds; 5.6 Contract/Lease Novations/Change of Control Consents & Notifications/Permitting & Licensing/IP; 5.7 Create Legal Entities For New Structure/Transfer Existing Entities/Assets/Employees to New Entities, as necessary; 5.8 Ensure Payroll in Place/Address Emp. Contracts/Retention Agreements/Pre-Close Onboarding Requirements; 5.9 Validate Completion of Conditions Precedent, Pre-Close Requirements & Announcement Plans/Finalize Documentation & Closing Package; and 5.10 Secure Approvals/Exchange Signatures & Closing Documents/Transfer Funds, Permission to Move Forward to Legally Close the Deal and Take Ownership of the Target.

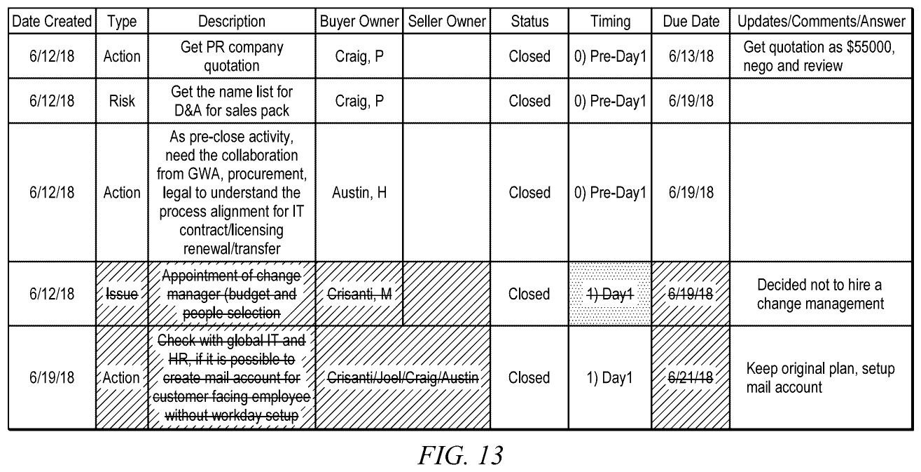

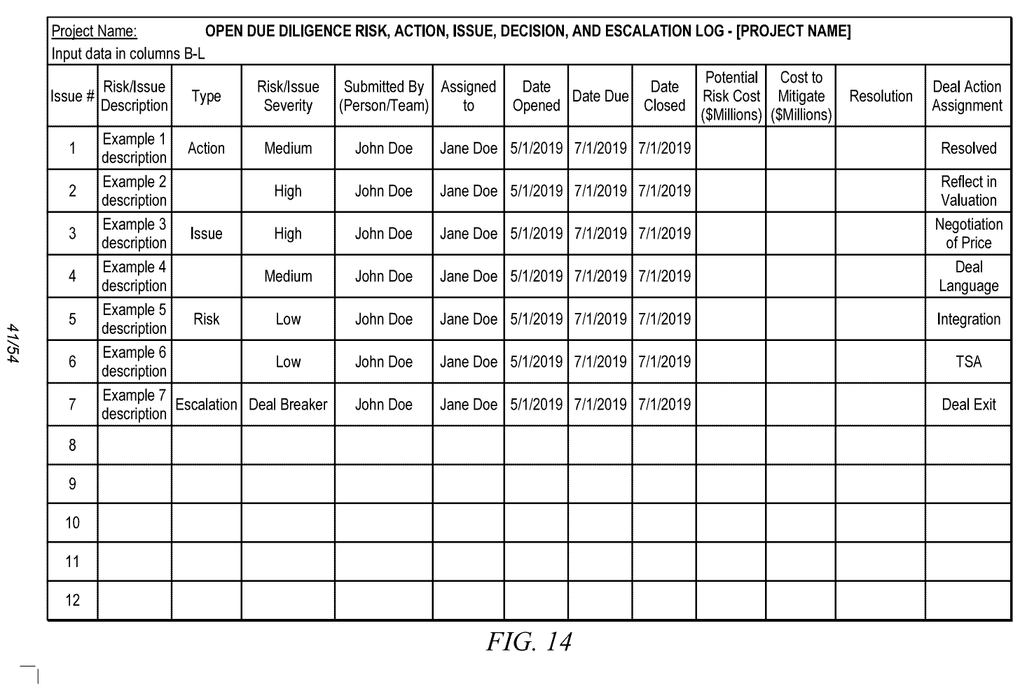

Each of these milestones has its own corresponding plurality of task-level details, as illustrated. Moreover, each of these task-level details has its own corresponding checklist of items, a subset of which is illustrated in FIGS. 13 and 14.

Turning now to FIG. 13, illustrated are exemplary steps used by the “Transaction Execution/Closing Prep” milestones and task levels of FIGS. 12A-D.

Turning now to FIG. 14, illustrated is an open due diligence risk, action, issue, decision and escalation log used by the “Transaction Execution/Closing Prep” milestones and task levels of FIGS. 12A-D.

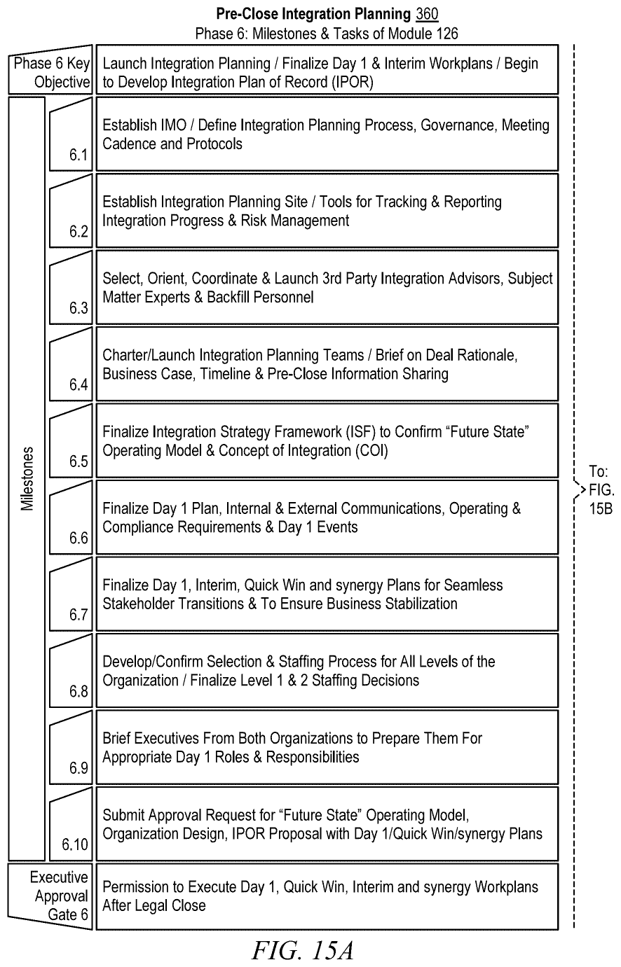

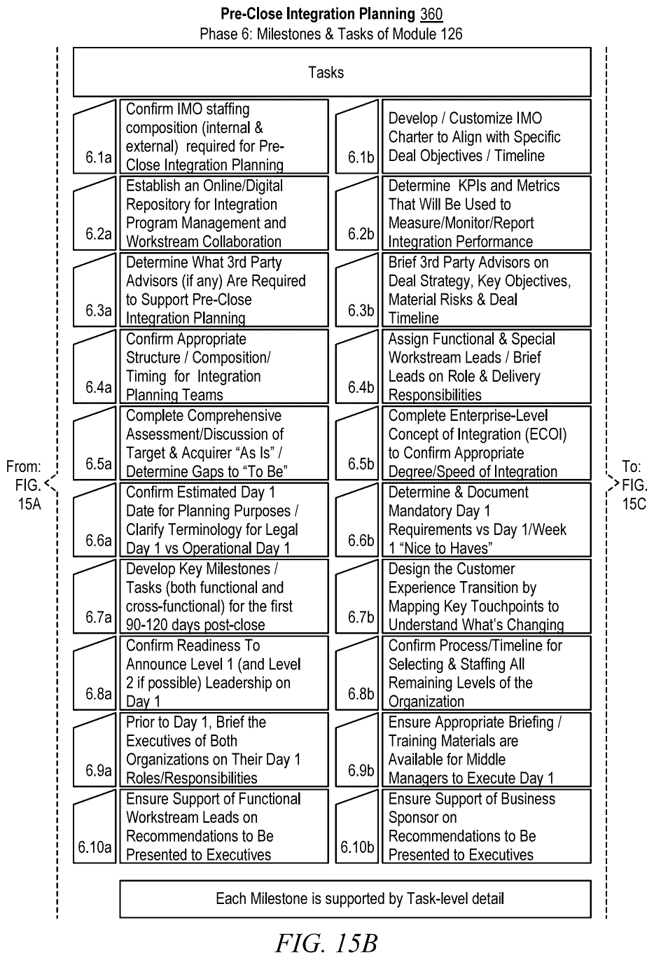

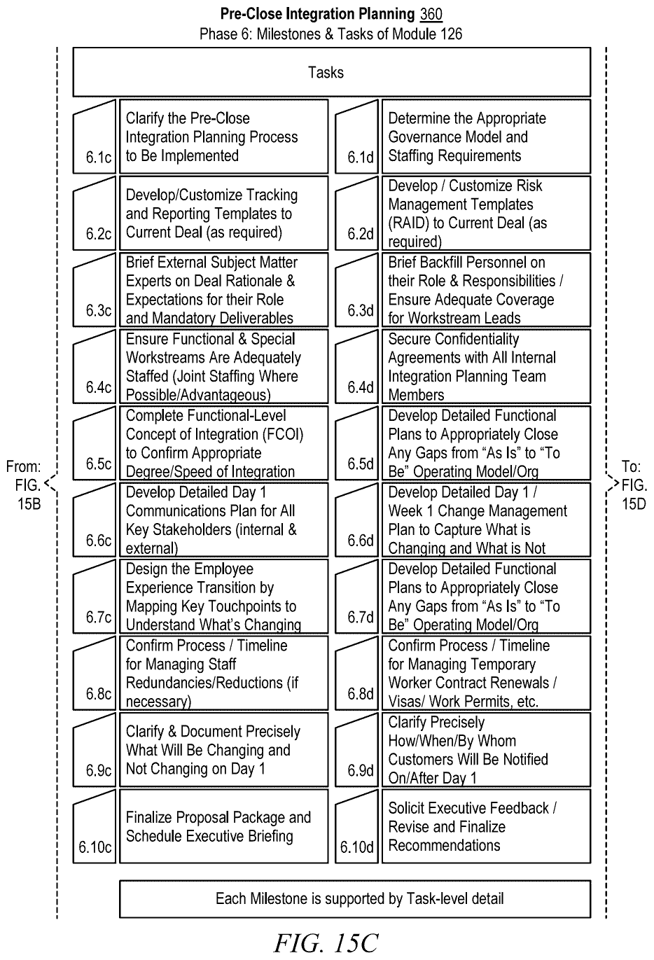

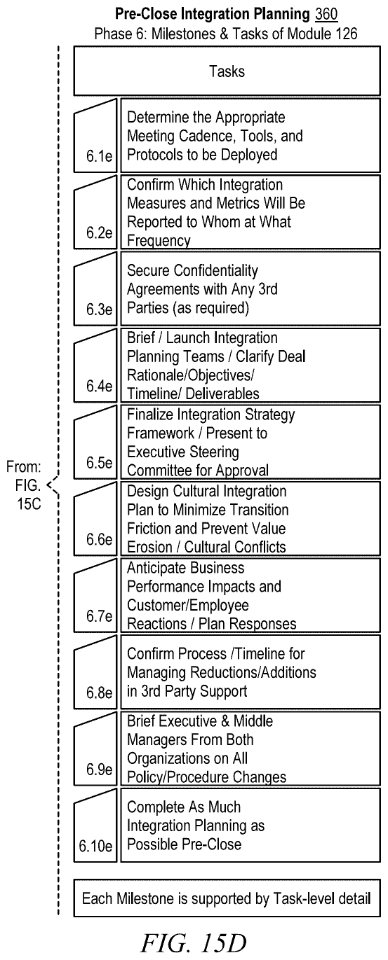

Turning now to FIG. 15A-D, illustrated are milestones and task-level detail processes of module 126. Each milestone is supported by task-level details which are invoked by the processes. The milestones include: 6.1 Establish IMO/Define Integration Planning Process, Governance, Meeting Cadence and Protocols; 6.2 Establish Integration Planning Site/Tools for Tracking & Reporting Integration Progress & Risk Management; 6.3 Select, Orient, Coordinate & Launch 3rd Party Integration Advisors, Subject Matter Experts & Backfill Personnel; 6.4 Charter/Launch Integration Planning Teams/Brief on Deal Rationale, Business Case, Timeline & Pre-Close Information Sharing; 6.5 Finalize Integration Strategy Framework (ISF) to Confirm “Future State”

Operating Model & Concept of Integration (COI); 6.6 Finalize Day 1 Plan, Internal & External Communications, Operating & Compliance Requirements & Day 1 Events; 6.7 Finalize Day 1, Interim, Quick Win and Synergy Plans for Seamless Stakeholder Transitions & To Ensure Business Stabilization; 6.8 Develop/Confirm Selection & Staffing Process for All Levels of the Organization/Finalize Level 1 & 2 Staffing Decisions; 6.9 Brief Executives From Both Organizations to Prepare Them For Appropriate Day 1 Roles & Responsibilities; 6.10 Submit Approval Request for “Future State” Operating Model, Organization Design, IPOR Proposal with Day 1/Quick Win/Synergy Plans, Permission to Execute Day 1, Quick Win, Interim and Synergy Workplans After Legal Close.

Each of these milestones has its own corresponding plurality of task-level details, as illustrated. Moreover, each of these task-level details has its own corresponding checklist of items, analogous to FIGS. 6A-F.

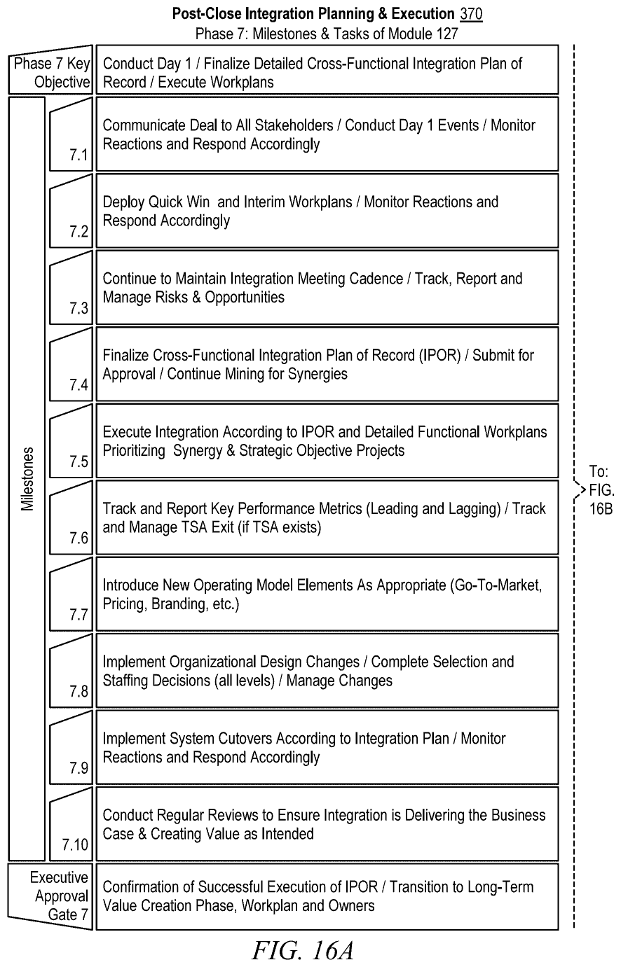

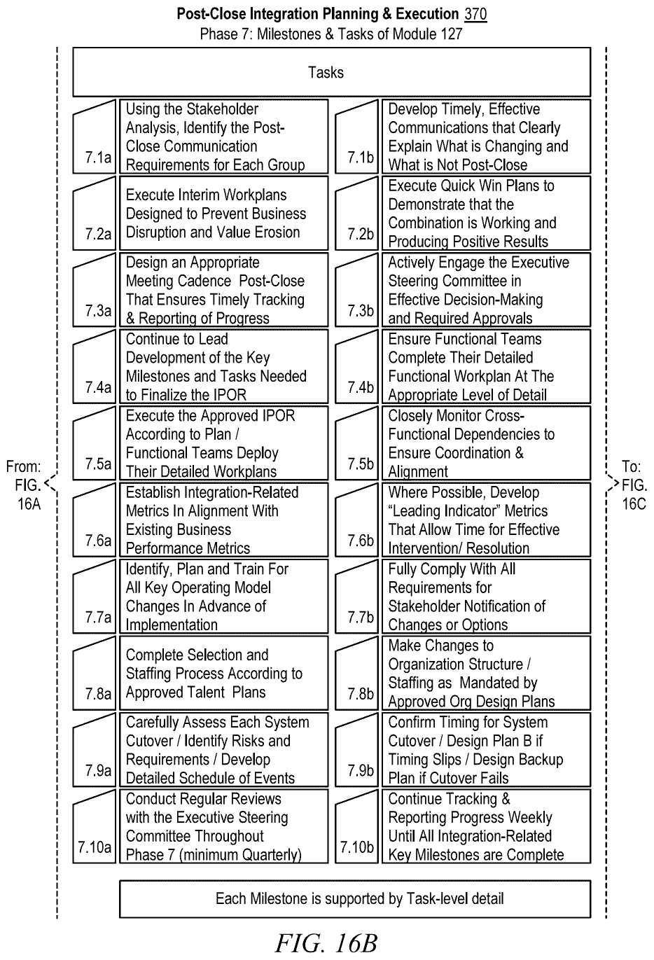

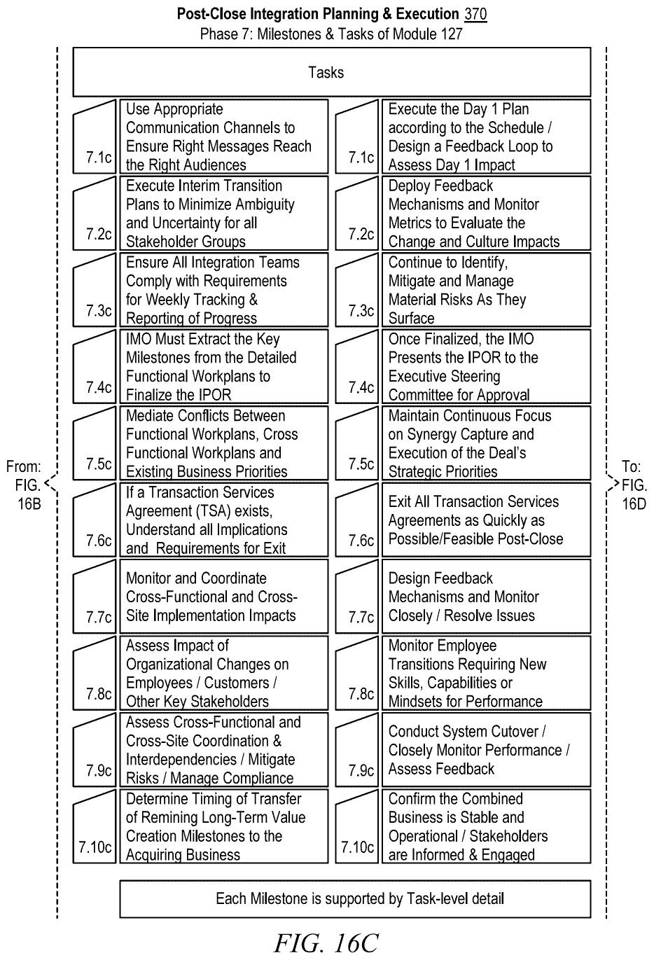

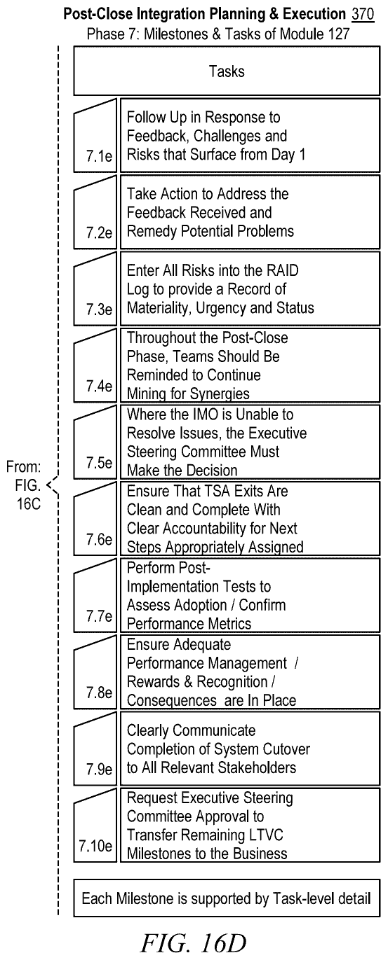

Turning now to FIGS. 16A-D, illustrated are milestones and task-level detail processes of module 127. Each milestone is supported by task-level details which are invoked by the processes. The milestones include: 7.1 Communicate Deal to All Stakeholders/Conduct Day 1 Events/Monitor Reactions and Respond Accordingly; 7.2 Deploy Quick Win and Interim Workplans/Monitor Reactions and Respond Accordingly; 7.3 Continue to Maintain Integration Meeting Cadence/Track, Report and Manage Risks & Opportunities; 7.4 Finalize Cross-Functional Integration Plan of Record (IPOR)/Submit for Approval/Continue Mining for Synergies; 7.5 Execute Integration According to IPOR and Detailed Functional Workplans Prioritizing Synergy & Strategic Objective Projects; 7.6 Track and Report Key Performance Metrics (Leading and Lagging)/Track and Manage TSA Exit (if TSA exists); 7.7 Introduce New Operating Model Elements As Appropriate (Go-To-Market, Pricing, Branding, etc.); 7.8 Staffing Decisions (all levels)/Manage Changes; 7.9 Implement System Cutovers According to Integration Plan/Monitor Reactions and Respond Accordingly; 7.10 Implement System Cutovers According to Integration Plan/Monitor Reactions and Respond Accordingly, Confirmation of Successful Execution of IPOR/Transition to Long-Term Value Creation Phase, Workplan and Owners.

Each of these milestones has its own corresponding plurality of task-level details, as illustrated. Moreover, each of these task-level details has its own corresponding checklist of items, analogous to FIGS. 6A-F.

Turning now to FIGS. 17A-D, illustrated are milestones and task-level detail processes of module 128. Each milestone is supported by task-level details which are invoked by the processes. The milestones include: 8.1 Ensure Long-Term Value Creation Workplan is Developed and Accountabilities for Achievement Assigned; Ensure Adequate Leadership, Governance, Program Management Accountability for Execution of Long-Term Workplan; 8.3; Ensure Adequate Budget and Appropriate Resources are Committed to Execute the Long-Term Workplan; 8.4 Execute Long-Term Workplans/Continue Mining for Synergies, Value Creation & Optimization Opportunities; 8.5 Complete Any Required Regulatory Exits/Legal Entity Consolidations/Tax Requirements/TSAs; 8.6 Complete Any Remaining Go-to-Market/Branding/Pricing/Service

Delivery Alignment; 8.7 Review Key Touchpoints in Customer Experience Journey/Gather Customer Feedback & Adjust as Necessary; 8.8 Review Key Touchpoints in Employee Experience Journey/Solicit Employee Feedback & Adjust as Necessary; 8.9 Conduct Cultural Assessment to Ensure Blended Culture Is Supporting Strategic & Business Objectives; and 8.10 Continue to Conduct Regular Reviews (Quarterly) Until All Deal Objectives Are Met and the Business Case is Achieved, Executive Approval That the Deal Has Met or Exceeded Its Strategic/Financial/Operational/Cultural Objectives/Program Closed.

Each of these milestones has its own corresponding plurality of task-level details, as illustrated. Moreover, each of these task-level details has its own corresponding checklist of items, analogous to FIGS. 6A-F.

Turning now to FIG. 18′, illustrated is an exemplary method 1300 of employment of artificial intelligence in conjunction with the method of FIG. 3. Each of the steps may be completed in conjunction with employment of the supervised learning sub-module 182, and/or the unsupervised learning sub-module 184, and/or the reinforcement learning sub-module 186.

After a start step, in a step 1310, a question or check-box item, which can be a milestone or a task-level detail and correlates to a phase, is selected. The method 1300 advances to a step 1320.

In the step 1320, the question is analyzed by AI according both an individual sentence and overall paragraph for context meaning. The method 1300 advances to a step 1330.

In the step 1330, the AI itself tries to answer a question after scraping for information from at least one of the internal database 140, and/or the first external database 160 and/or the second external database 170. This question can be an updated question as modified by AI according to its sentence-structure analysis. The method 1300 advances to a step 1340.

In some embodiments, the databases 140 can contain various templates and spreadsheets employed by the MA software 120, and the databases 140, 160, 170 can also contain relevant business information such as credit scores, corporate histories, web sites of corporations, etc. or anything else that might be of interest during the M&A process of the M&A software 120.

In a step 1340, a combined answer is provided by the AI. The combined answer includes an analysis of both the sentence structure and the complete paragraph, run through an AI engine, such as Chat GPT, to answer a given question from scraping the database. The method 1300 advances to step 1350.

In an optional step 1350, a user can override either the updated question, the scraped answer, or both. This can be a form of quality control. The method 1300 advances to a step 1360.

In a step 1360, the combined answer is employed as an input to the next question or data to be analyzed by the AI. The method then stops.

Any of the functions disclosed herein may be implemented using various means for performing those functions. Such means include, but are not limited to, any of the components disclosed herein, such as the computer-related components described below.

The techniques described above may be implemented, for example, in hardware, one or more computer programs tangibly stored on one or more computer-readable media, firmware, or any combination thereof. The techniques described above may be implemented in one or more computer programs executing on (or executable by) a programmable computer including any combination of any number of the following: a processor, a storage medium readable and/or writable by the processor (including, for example, volatile and non-volatile memory and/or storage elements), an input device, and an output device. Program code may be applied to input entered using the input device to perform the functions described and to generate output using the output device.

Embodiments of the present invention include features which are only possible and/or feasible to implement with the use of one or more machines, such as computers, computer processors, and/or other elements of a computer system. Such features are either impossible or impractical to implement mentally and/or manually. For example, embodiments of the present invention read data from a machine-readable object, such as by using a wand to read data from a chip. This function cannot be performed by a human manually or mentally.

Any claims herein which affirmatively require a computer, a processor, a memory, or similar computer-related elements, are intended to require such elements, and should not be interpreted as if such elements are not present in or required by such claims. Such claims are not intended, and should not be interpreted, to cover methods and/or systems which lack the recited computer-related elements. For example, any method claim herein which recites that the claimed method is performed by a computer, a processor, a memory, and/or similar computer-related element, is intended to, and should only be interpreted to, encompass methods which are performed by the recited computer-related element(s).

Such a method claim should not be interpreted, for example, to encompass a method that is performed mentally or by hand (e.g., using pencil and paper). Similarly, any product claim herein which recites that the claimed product includes a computer, a processor, a memory, and/or similar computer-related element, is intended to, and should only be interpreted to, encompass products which include the recited computer-related element(s). Such a product claim should not be interpreted, for example, to encompass a product that does not include the recited computer-related element(s).

Each computer program within the scope of the claims below may be implemented in any programming language, such as assembly language, machine language, a high-level procedural programming language, or an object-oriented programming language. The programming language may, for example, be a compiled or interpreted programming language.

Each such computer program may be implemented in a computer program product tangibly embodied in a machine-readable storage device for execution by a computer processor. Method steps of the invention may be performed by one or more computer processors executing a program tangibly embodied on a computer-readable medium to perform functions of the invention by operating on input and generating output. Suitable processors include, by way of example, both general and special purpose microprocessors.

Generally, the processor receives (reads) instructions and data from a memory (such as a read-only memory and/or a random-access memory) and writes (stores) instructions and data to the memory. Storage devices suitable for tangibly embodying computer program instructions and data include, for example, all forms of non-volatile memory, such as semiconductor memory devices, including EPROM, EEPROM, and flash memory devices; magnetic discs such as internal hard discs and removable discs; magneto-optical discs; and CD-ROMs. Any of the foregoing may be supplemented by, or incorporated in, specially designed ASICs (application-specific integrated circuits) or FPGAs (Field-Programmable Gate Arrays).

A computer can generally also receive (read) programs and data from, and write (store) programs and data to, a non-transitory computer-readable storage medium such as an internal disc (not shown) or a removable disc. These elements will also be found in a conventional desktop or workstation computer as well as other computers suitable for executing computer programs implementing the methods described herein, which may be used in conjunction with any digital print engine or marking engine, display monitor, or other raster output device capable of producing color or gray scale pixels on paper, film, display screen, or other output medium.

Any data disclosed herein may be implemented, for example, in one or more data structures tangibly stored on a non-transitory computer-readable medium. Embodiments of the invention may store such data in such data structure(s) and read such data from such data structure(s).

Although the present disclosure and its advantages have been described in detail, it should be understood that various changes, substitutions and alterations can be made herein without departing from the spirit and scope of the disclosure as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure, processes, machines, manufacture, compositions of matter, means, methods, or steps, presently existing or later to be developed that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

What is claimed is:

1. A computerized M&A facilitation system, comprising:
a server including merger and acquisition software, the M&A software including:
an M&A strategy and governance module.

2. The system of claim 1, wherein the M&A software further includes a targeting module.

3. The system of claim 1, wherein the M&A software further includes a preliminary due diligence module.

4. The system of claim 1, wherein the M&A software further includes a confirmatory due diligence module.

5. The system of claim 1, wherein the M&A software further includes a transaction execution/closing preparation module.

6. The system of claim 1, wherein the M&A software further includes a pre-close integration planning module.

7. The system of claim 1, wherein the M&A software further comprises a post-close integration planning and execution module.

8. The system of claim 1, wherein the M&A software further comprises a long-term value creation module.

9. A computerized M&A facilitation method, comprising the steps of:
devising a merger and/or acquisition strategy according to an M&A software;
targeting a business for merger and/or acquisition according to the M&A software;
conducting preliminary due diligence according to the M&A software; and
conducting confirmatory due diligence according to the M&A software.

10. The method of claim 9, further comprising: executing transaction/closing preparation according to the M&A software.

11. The method of claim 9, further comprising: conducting pre-closing integration planning according to the M&A software.

12. The method of claim 9, further comprising: conducting post closing planning and execution according to the M&A software.

13. The method of claim 9, further comprising: harvesting long-term value creation according to the M&A software.

14. The method of claim 9, wherein the means for devising the merger and/or acquisition strategy according to the M&A software further includes the steps of:
reviewing industry, market, customer, competitive, SWOT, gap analysis capabilities/inventories;
understanding corporate and segment future state view/capability and rouse gaps to be filled/priority and timeframes; and
understanding directives for core/adjacent/unfamiliar industry/offering.

15. A computerized M&A facilitation method, comprising:
selecting a question within an M&A software; and
analyzing the question/status by both paragraph structure and sentence structure by AI associated with the M&A software.

16. The method of claim 15, further comprising:
automated AI-directed scraping for information to enter into the M&A software by the analyzed question.

17. The method of claim 15, further comprising:
providing a combined answer by the AI of the M&A software.

18. The method of claim 15, wherein said AI employs supervised learning.

19. The method of claim 15, wherein said AI employs unsupervised learning.

20. The method of claim 15, wherein said AI employs reinforcement learning.
